(19) United States
(12) Patent Application Publication
(10) Pub. No.: US 2015/0239203 A1
(43) Pub. Date: Aug. 27, 2015

(54) SYSTEMS AND METHODS FOR PROVIDING COUPLABLE ORNAMENTS

(71) Applicant: Trevor Norcross, Shoreline, WA (US)

(72) Inventor: Trevor Norcross, Shoreline, WA (US)

(21) Appl. No.: 14/661,271

(22) Filed: Mar. 18, 2015

Related U.S. Application Data
(63) Continuation-in-part of application No. 13/528,822, filed on Jun. 20, 2012.

(51) Int. Cl. B32B 3/26; B32B 3/08

(52) U.S. Cl. CPC B32B 3/266; B32B 3/08; B32B 2451/00

(57) ABSTRACT

A couplable ornament may be a five-pointed star, a rectangle or other form, and be configured for coupling to other ornaments using a ball-and-socket construction, magnets, tabs and slots or other coupling means. The ornament may have words or designs with significance to an individual or organization, and a plurality of ornaments may be awarded over time with different markings or words where the plurality of ornaments couple with one another. A system of couplable ornaments may be an employee achievement recognition system in which the ornaments are awarded by an organization to employees over time to mark particular individual or organizational milestones, where the ornaments may be coupled together by recipients to form shapes, structures or other designs constructed from the individual ornaments. The ornament may have two halves forming an ornamental member with the ability to receive decorative elements such as a substrate and/or a snap-in ring.

### PRIORITY CLAIM

The present application constitutes a continuation-in-part of U.S. patent application Ser. No. 13/528,822, entitled SYSTEMS AND METHODS FOR PROVIDING COUPLABLE ORNAMENTS (our ref. NORC-1-1001-1), naming Trevor Norcross as the inventor, filed Jun. 20, 2012, which is currently co-pending. The foregoing application is hereby incorporated by reference in its entirety as if fully set forth herein.

### FIELD OF THE INVENTION

This invention relates generally to ornaments, and more specifically, to systems and methods for providing couplable ornaments.

### BACKGROUND

New opportunities exist for ornaments which couple together. Accordingly, this application discloses systems and methods for providing couplable ornaments.

### SUMMARY

This invention relates generally to ornaments, and more specifically, to systems and methods for providing couplable ornaments.

In some embodiments, an ornament may comprise an ornamental member configured to removably couple with another ornament; and a decorative element fastened to the ornamental member. In some embodiments, the ornament may include one or more protrusions extending from the ornamental member, each protrusion including at least a ball, the ball at an end of the protrusion opposite the ornamental member; and one or more sockets defined within the ornamental member, each socket configured for removably receiving a ball of another ornament. In some embodiments, the one or more protrusions and one or more sockets comprise a ball-and-socket construction for removably coupling a first ornament with at least a second ornament. In some embodiments, the ball-and-socket construction is configured for a first and a second coupled ornament to at least one of rotate, swivel, pivot or articulate relative to one another.

In some embodiments, the ornament may comprise one or more magnets, each magnet configured for removably coupling a first ornament with at least a second ornament. In some embodiments, the ornament may comprise a means for removably coupling a first ornament with at least a second ornament.

In some embodiments, the decorative element fastened to the ornamental member comprises a decorative element that is at least partially embedded within an interior region of the ornamental member. In some embodiments, the decorative element fastened to the ornamental member comprises a substrate, the substrate including a design disposed on at least a first face of the substrate. In some embodiments, the decorative element fastened to the ornamental member comprises a printable surface. In some embodiments, the printable surface is configured for an image to be printed on the printable surface, the image printed on the printable surface subsequent to manufacturing of the ornamental member and decorative element, the image printed on the printable surface prior to fastening the decorative element to the ornamental member, wherein manufacturing of the ornamental member and decorative element occurs at a different location than a location where the image is printed and where the decorative element is fastened to the ornamental member.

In some embodiments, the ornamental member configured to removably couple with another ornament further comprises a front face and a rear face, wherein one or more channels are disposed through the ornamental member, the one or more channels having at least a first aperture disposed through the front face. In some embodiments, the first aperture is configured for receiving one or more of a gem or a shaft of a pin. In some embodiments, the channel is configured for receiving a means for mounting the ornament to a structure.

In some embodiments, the ornament may comprise a snap-in ring, wherein the ornamental member includes a recess configured for removably receiving the snap-in ring. In some embodiments, the ornament may be substantially in the shape of one of a five-pointed star, a four-pointed star, a rectangle, a heart, a triangle, a cross, a hexagon, or a trapezoid. In some embodiments, the ornament is an employee achievement award given by an organization to an employee. In some embodiments, at least one of the ornamental member, the decorative element or the snap-in ring have one or more words disposed on an exterior surface, the one or more words including words embodying values of the organization. In some embodiments, at least a portion of the ornament is manufactured from material used in manufacturing a product distributed by the organization to non-employees.

In some embodiments, a system for rewarding employee achievement comprises a plurality of employee achievement awards, the employee achievement awards comprising one or more ornaments configured to removably interlock with other ornaments, the one or more ornaments including one or more of: words disposed on the ornament, the words including words with special meaning for an organization awarding the employee achievement awards; ornaments manufactured at least partially from material used in manufacturing a product distributed by the organization awarding the employee achievement awards; one or more apertures on a face of the ornament, the one or more apertures configured for receiving one or more of a gem, a shaft of a pin, or a means for mounting the ornament; and/or an interior substrate, the interior substrate including a design having special significance for employees of an organization awarding the employee achievement awards, the interior substrate being at least partially embedded within an ornamental member defining a periphery of the ornament, wherein each of the one or more ornaments includes substantially the same exterior shape, profile and means for removably interlocking with other ornaments.

In some embodiments, a method for rewarding employee achievement, comprises: adopting a system for rewarding employee achievement, wherein the system for rewarding employee achievement includes at least an ornament configured to interlock with other ornaments, wherein the ornament includes aspects with cultural significance for the organization adopting the system for rewarding employee achievement; providing ornaments to one or more employees for one or more of individual achievement, organizational achievement, milestones, or seeding a workforce with an initial award of one or more ornaments; receiving input from one or more employees, the input pertaining to design of one or more aspects of the ornament for future awards; evaluating the input from one or more employees; incorporating selected input from one or more employees in a new ornament, the new ornament maintaining substantially the same exterior shape, profile and means for removably interlocking with other ornaments as previously provided ornaments; and providing new ornaments to one or more employees for one or more of individual achievement, organizational achievement or milestones.

In addition to the foregoing, various other method and/or system aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the detailed description set forth herein.

### BRIEF DESCRIPTION OF THE DRAWINGS

Embodiments of the present invention are described in detail below with reference to the following drawings:

FIGS. 1a and 1b are a top view and a perspective view of a couplable ornament, in accordance with an embodiment of the invention;

FIGS. 2a, 2b, 2c and 2d are a top view, a top view, a perspective view and a perspective view, respectively, of a plurality of couplable ornaments, in accordance with an embodiment of the invention;

FIGS. 3a, 3b and 3c are a bottom view, a side view and a top view of a half of an ornamental member of a couplable ornament, in accordance with an embodiment of the invention;

FIG. 4 is a perspective view of a decorative element of a couplable ornament, in accordance with an embodiment of the invention;

FIGS. 5a and 5b are a perspective view and a cutaway side view of a snap-in ring of a couplable ornament, in accordance with an embodiment of the invention;

FIG. 6 is an exploded view of a couplable ornament, in accordance with an embodiment of the invention;

FIG. 7 is an exploded view of a couplable ornament, in accordance with an embodiment of the invention;

FIGS. 8a and 8b are a top view of an alternate embodiment of a snap-in ring and a top view of an alternate embodiment of a couplable ornament, in accordance with an embodiment of the invention;

FIGS. 9a and 9b are top views of alternate embodiments of a couplable ornament, in accordance with embodiments of the invention;

FIG. 10 is a top view of coupled alternate embodiments of a couplable ornament, in accordance with embodiments of the invention;

FIGS. 11a and 11b are a top view and a perspective view of a couplable ornament, in accordance with an embodiment of the invention;

FIGS. 12a, 12b, 12c and 12d are various top views of pluralities of couplable ornaments, in accordance with an embodiment of the invention;

FIGS. 13a, 13b, 13c, 13d and 13e are a front view, a rear view, a cutaway side view, a front perspective view and a rear perspective view of a portion of an ornamental member, in accordance with an embodiment of the invention;

FIG. 14 is a perspective view of a decorative element of a couplable ornament, in accordance with an embodiment of the invention;

FIG. 15 is a perspective view of a snap-in ring of a couplable ornament, in accordance with an embodiment of the invention;

FIGS. 16a, 16b and 16c are various exploded views of portions of a couplable ornament, in accordance with an embodiment of the invention;

FIGS. 17a, 17b, 17c and 17d are various views of pluralities of various embodiments of couplable ornaments, in accordance with varied embodiments of the invention;

FIG. 18a is a perspective view of a plurality of couplable ornaments, in accordance with an embodiment of the invention;

FIG. 18b is a perspective view of a plurality of couplable ornaments, in accordance with an embodiment of the invention;

FIGS. 18c and 18d are a top view and a side view of an ornament, in accordance with an embodiment of the invention;

FIG. 18e is a side view of an ornament, in accordance with an embodiment of the invention;

FIG. 18f is a side view of an ornament, in accordance with an embodiment of the invention;

FIGS. 18g, 18h, and 18i are top views of an attachment arrangement configured for removably coupling ornaments, in accordance with an embodiment of the invention;

FIG. 18j is a perspective view of an attachment arrangement for compressibly removably coupling a first ornament with a second ornament;

FIG. 18k is a front view of an ornament, in accordance with an embodiment of the invention;

There is no FIG. 18l because it could be read as “FIG. 181”;

FIG. 18m is a perspective view of two coupled ornaments, in accordance with an embodiment of the invention;

FIG. 18n is a front view of an ornament, in accordance with an embodiment of the invention;

FIG. 18o is a perspective view of two coupled ornaments, in accordance with an embodiment of the invention;

FIG. 19 is a system diagram of a system for rewarding employee achievement, in accordance with an embodiment of the invention; and

FIG. 20 is a flow diagram of a method for rewarding employee achievement, in accordance with an embodiment of the invention.

### DETAILED DESCRIPTION

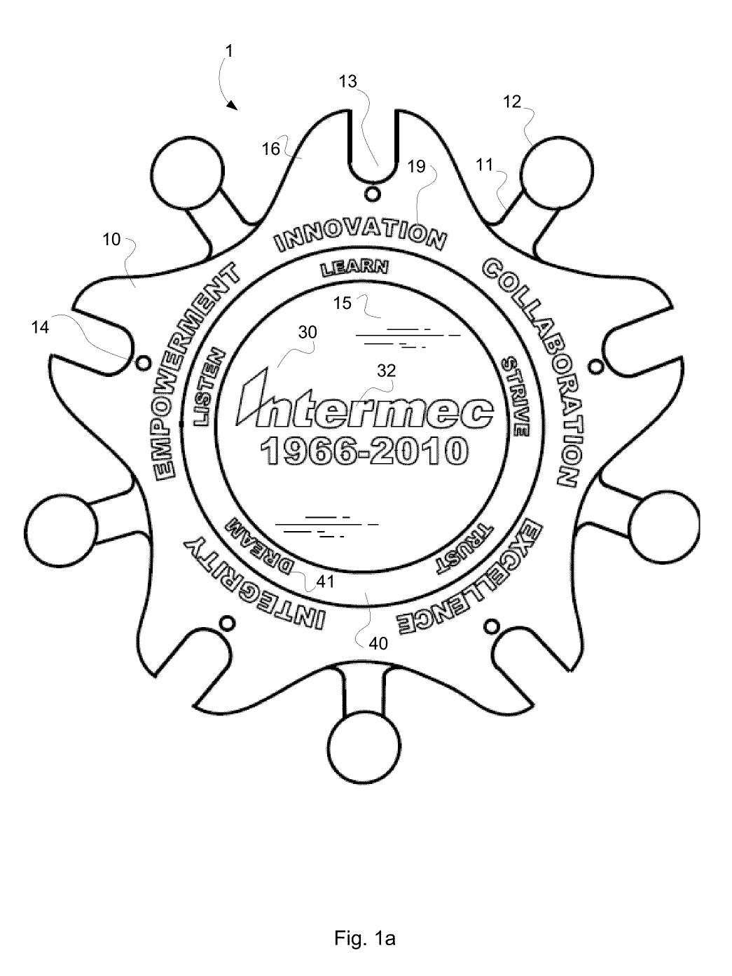

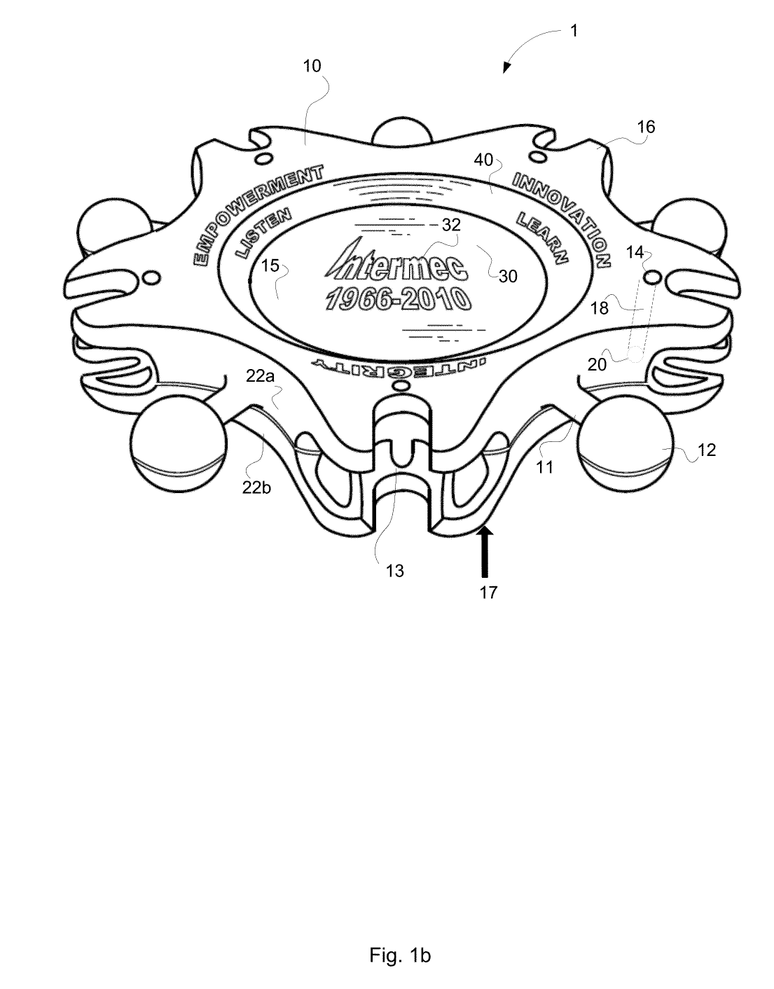

This invention relates generally to ornaments, and more specifically, to systems and methods for providing couplable ornaments. Specific details of certain embodiments of the invention are set forth in the following description and FIGS. 1-20 and the APPENDIX to provide a thorough understanding of such embodiments. The present invention may have additional embodiments, may be practiced without one or more of the details described for any particular described embodiment, or may have any detail described for one particular embodiment practiced with any other detail described for another embodiment.

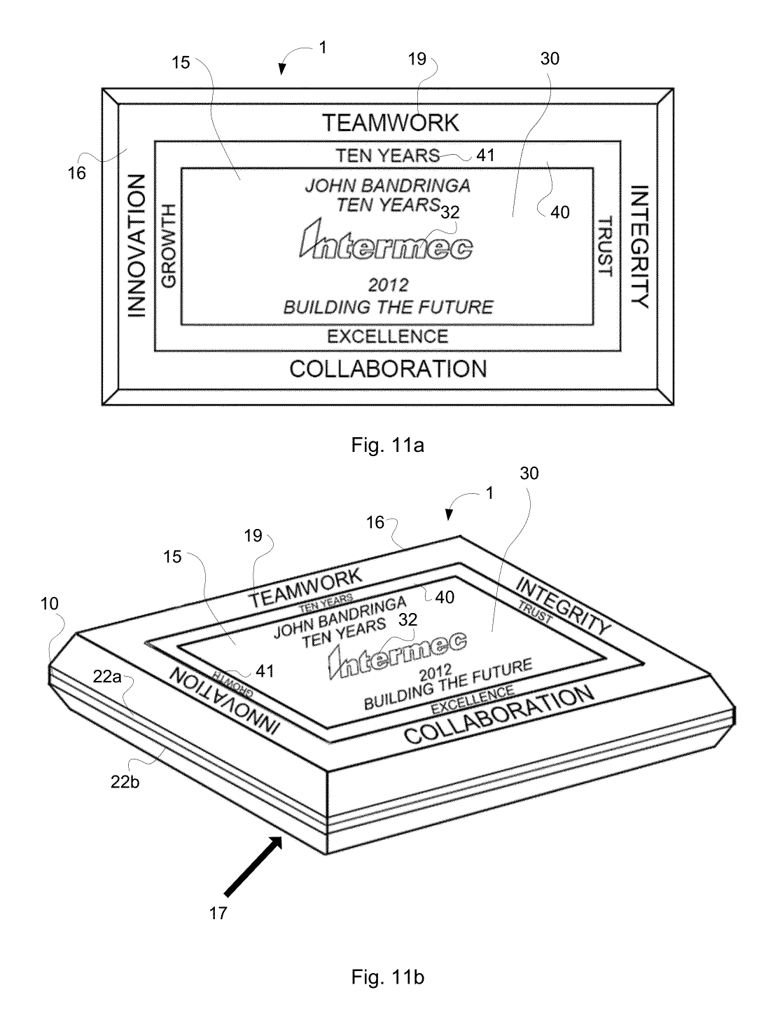

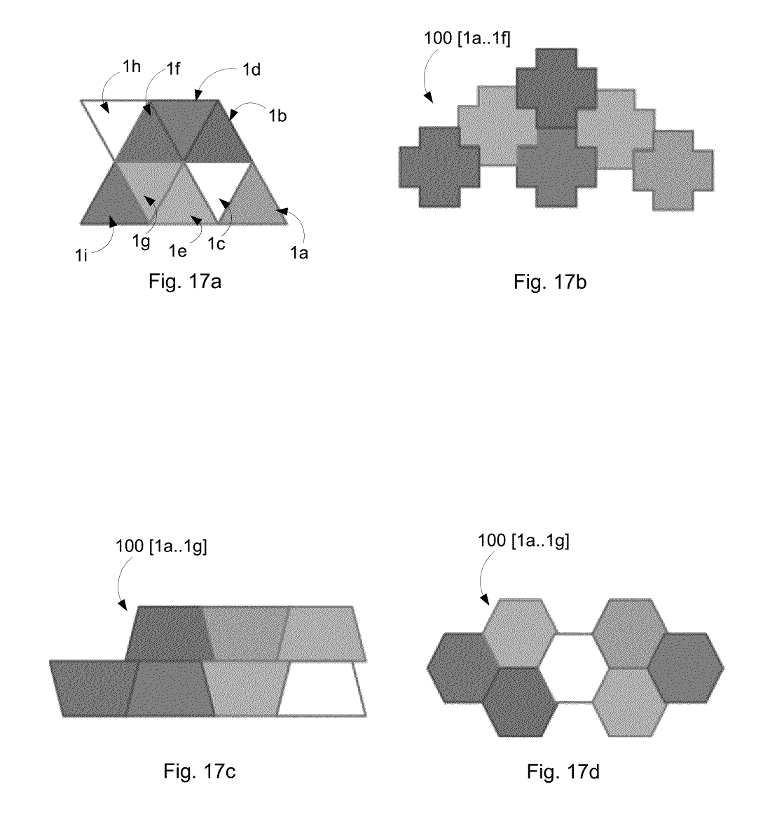

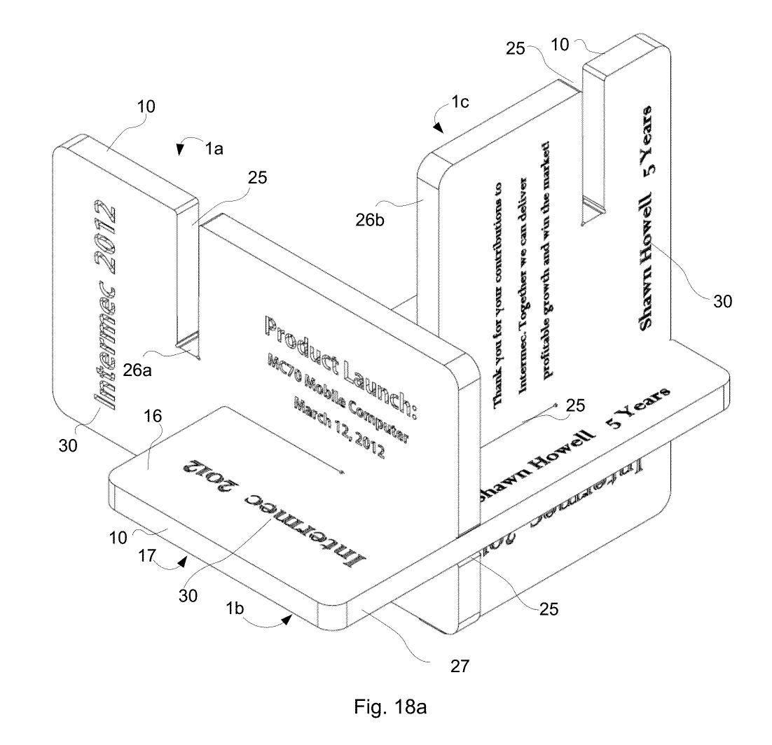

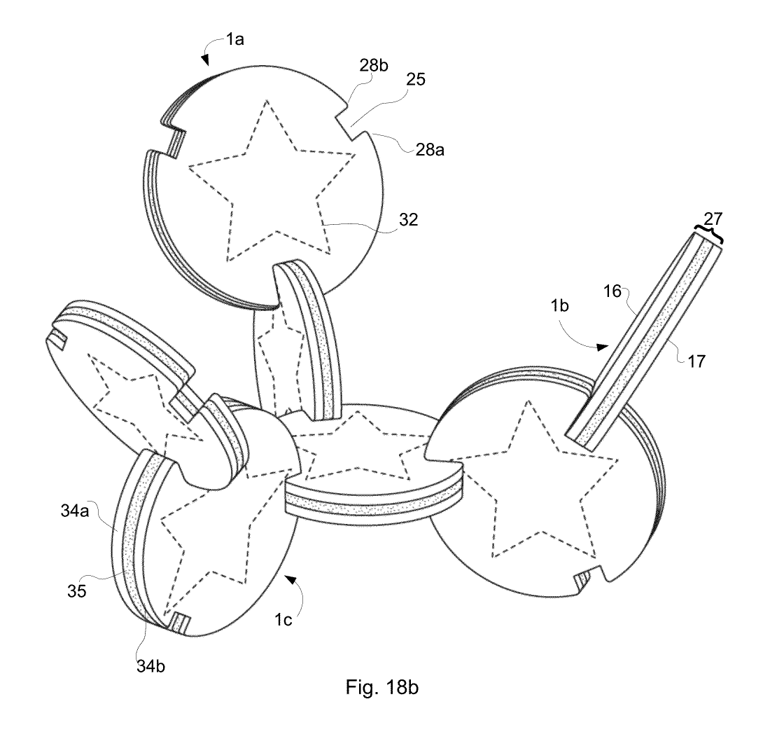

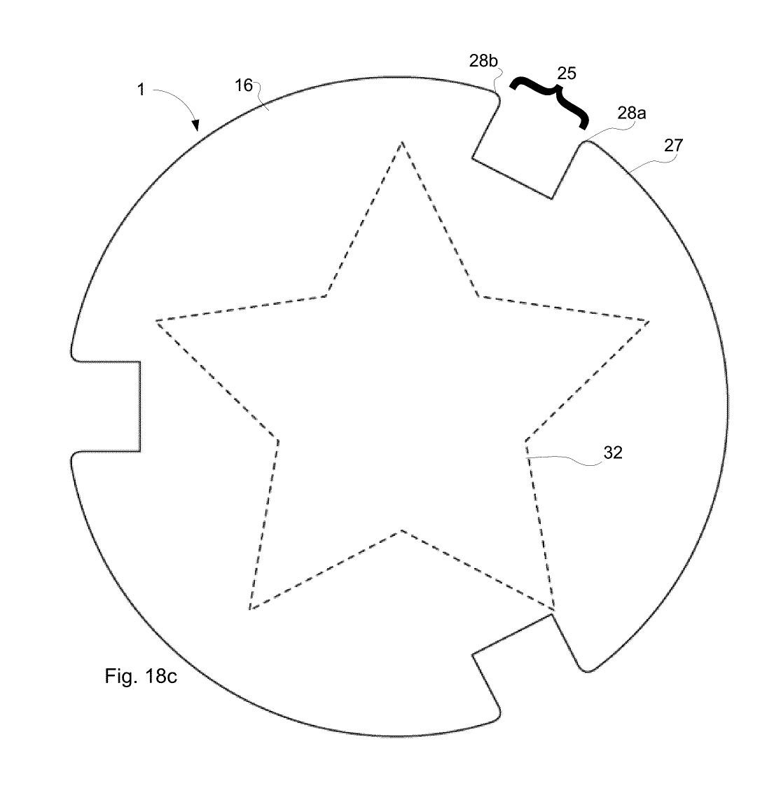

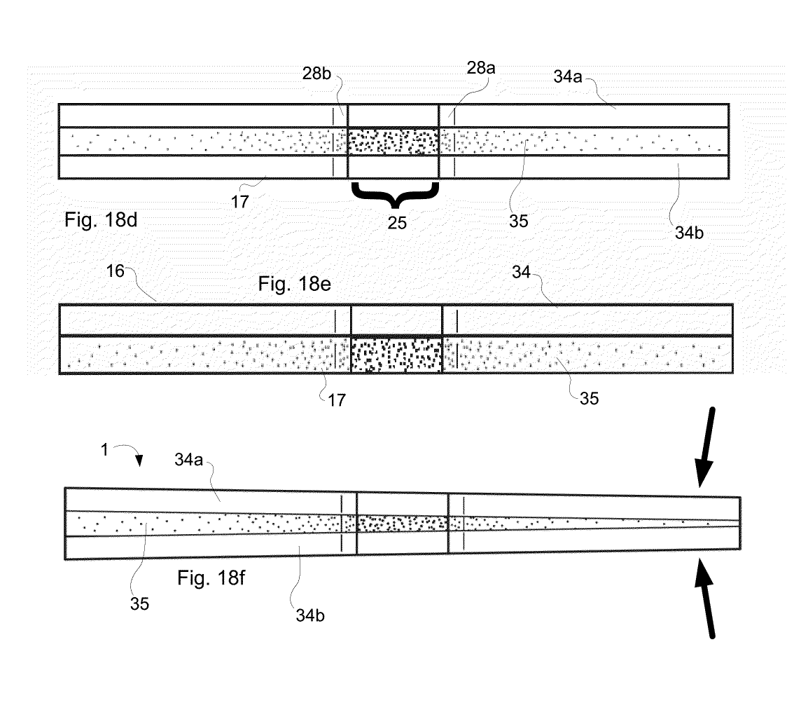

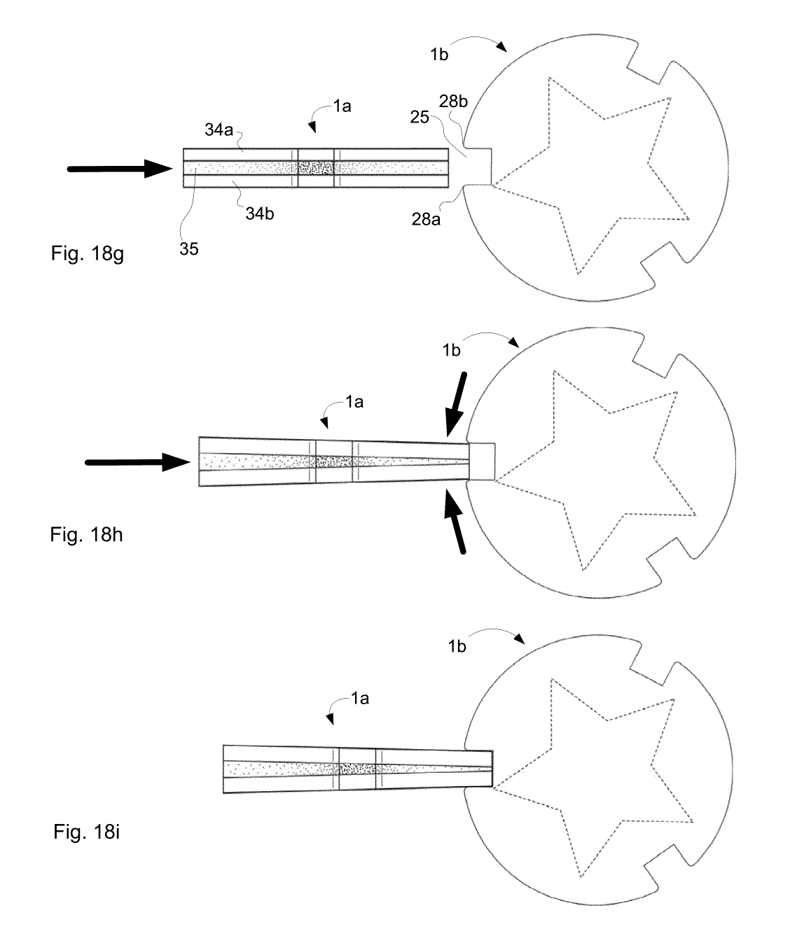

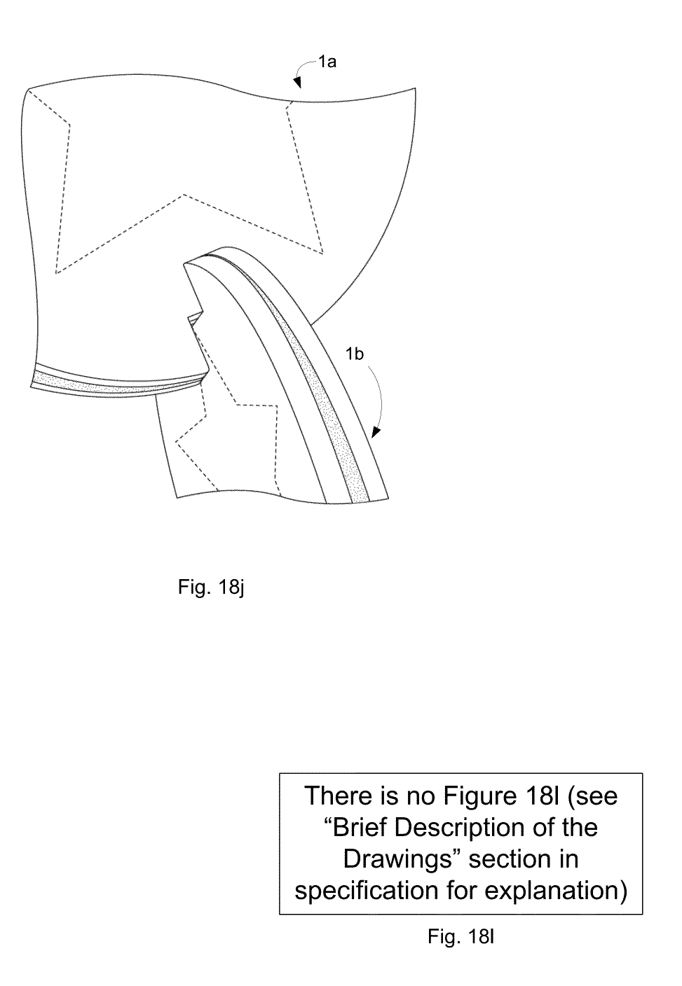

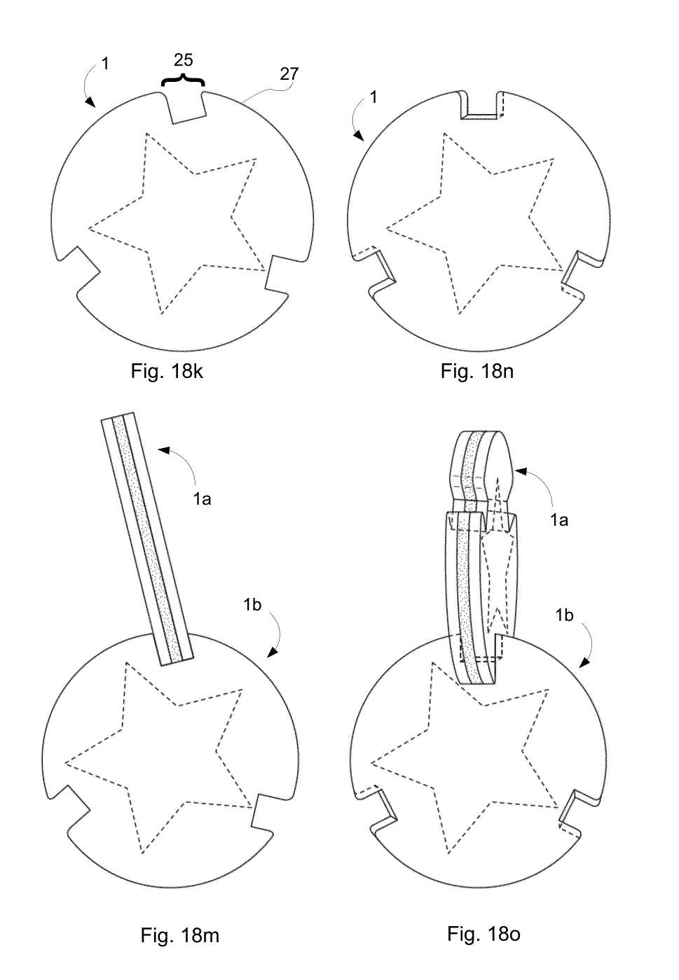

FIGS. 1a and 1b are a top view and a perspective view of a couplable ornament, in accordance with an embodiment of the invention. FIGS. 11a and 11b are a top view and a perspective view of a couplable ornament, in accordance with an embodiment of the invention. FIGS. 17a, 17b, 17c and 17d are various views of pluralities of various embodiments of couplable ornaments, in accordance with varied embodiments of the invention. FIG. 18a is a perspective view of a plurality of couplable ornaments, in accordance with an embodiment of the invention.

In some embodiments, a couplable ornament 1 may be substantially in the shape of one of a five-pointed star, a four-pointed star, a rectangle, a heart, a triangle, a cross, a hexagon, or a trapezoid. In different embodiments, a couplable ornament may take on a different shape, wherein a plurality of ornaments have a similar shape and substantially similar means of coupling the ornament, wherein a plurality of ornaments may be coupled and shapes or designs may be formed from the plurality of ornaments. For example, a “ball-and-socket” type ornament may couple with other ball-and-socket ornaments, whether the other ball-and-socket ornaments have the same physical geometry (i.e. five-pointed stars coupling with other five-pointed stars) or the other ball-and-socket ornaments have different physical geometry (i.e. five-pointed stars coupling with four-pointed stars or heart-shaped ornaments). In some embodiments, an ornament may have one means of coupling, or may have multiple means of coupling, for example a ball-and-socket construction and a plurality of channels through which string or wire may be threaded for coupling ornaments, or a ball-and-socket construction and magnets.

In some embodiments, a couplable ornament 1 may be comprised of an ornamental member 10 and a decorative element 30, where the decorative element is fastened to the ornamental member. In some embodiments, the decorative element may be at least partially embedded within an interior region 15 of the ornament member, as is shown, for example, in FIGS. 1a and 11a. The interior region of the ornamental member may be an opening, hollow, void, channel, aperture or other area in which a decorative element may be visible within the ornament. In different embodiments, the decorative element may be a region of the ornamental member, as is shown, for example, in FIG. 18a. In some embodiments, an ornamental member 10 may be comprised of two halves of the ornamental member 22a and 22b. In some embodiments, two halves of the ornamental member 22 may be identical. In different embodiments, the ornamental member may be constructed of differently-shaped components, or may be one piece.

In some embodiments, an ornament 1 may have a snap-in ring 40. The snap-in ring may couple with another element of the ornament, such as the ornamental member 10 or the decorative element 30. In some embodiments, a snap-in ring may be circular in shape. In different embodiments, a snap-in ring may be rectangular, square or triangular. In varied embodiments, a snap-in ring may have different numbers of sides up to 20 sides.

In some embodiments, an ornament 1 may have components which are decorated, adorned, printed, engraved, designed, or otherwise have visually appealing aspects particular to the ornaments. In some embodiments, the ornament may have a plurality of words. The words may be stamped, tooled, engraved, screened, printed, inked, adhered, stenciled, or otherwise applied to the ornament by other means. In other embodiments, the ornament may have graphic designs applied using the foregoing processes or different processes. In some embodiments, the words may be applied to the ornamental member as shown at 19, the decorative element as shown at 32 or the snap-in ring as shown at 41. In place of the words may be any graphic design that is visually appealing or that has special meaning.

In some embodiments, the decorative element 30 fastened to the ornamental member 10 may be a substrate, the substrate including a design 32 disposed on at least a first face of the substrate. In some embodiments, the design disposed on at least a first face of the substrate includes words, logos, images, or other graphic elements. In some embodiments, the substrate may be a material in which a design may be engraved, embossed, or applied using a different process such as any imaging process disclosed elsewhere herein. In different embodiments, the substrate may be a printable surface. In some embodiments, the printable surface is configured for an image to be printed on the printable surface, the image printed on the printable surface subsequent to manufacturing of the ornamental member 10 and decorative element, the image printed on the printable surface prior to fastening the decorative element to the ornamental member, and wherein manufacturing of the ornamental member and decorative element occurs at a different location than a location where the image is printed and where the decorative element is fastened to the ornamental member. For example, the ornament 1 may be provided as a kit including the ornamental member that is disassembled into halves and the decorative element having a surface on which the design can subsequently be applied, enabling a degree of customization of the ornaments to occur at a site other than the manufacturing location for the components. In different embodiments, words or designs may be applied to other components of the ornament post-manufacturing and distribution of the kit, such as the ornamental member or snap-in ring. In some embodiments, the ornament is an employee achievement award given by an organization to an employee. In some embodiments, at least one of the ornamental member, the decorative element or the snap-in ring have one or more words disposed on an exterior surface, the one or more words including words embodying values of the organization.

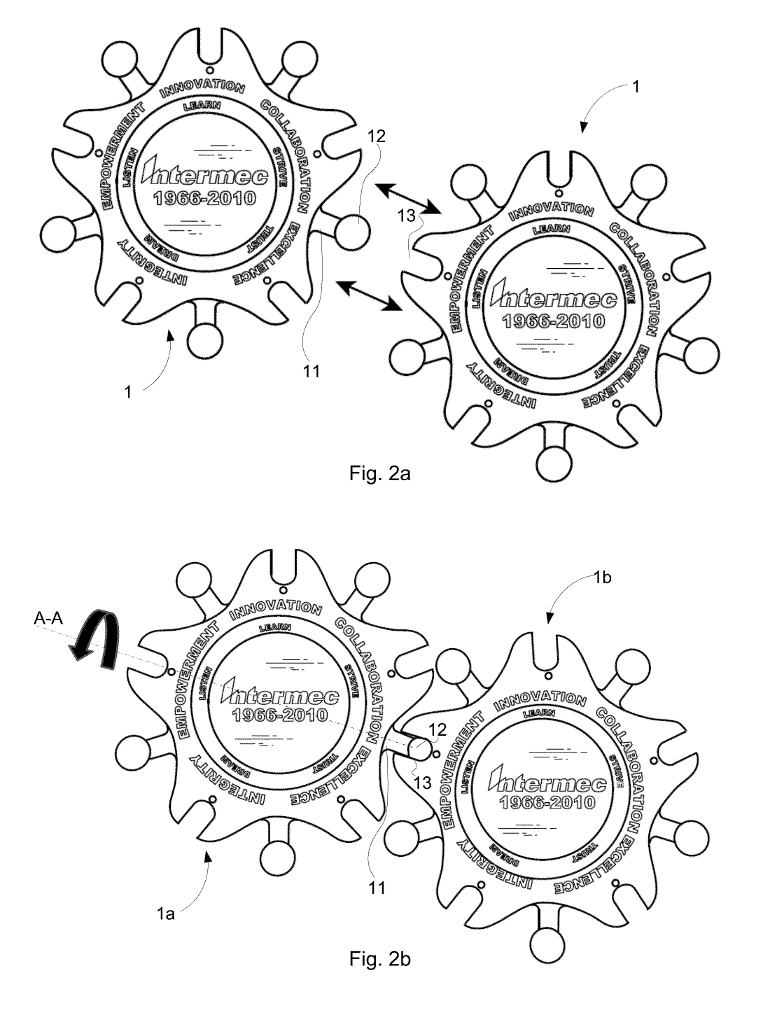

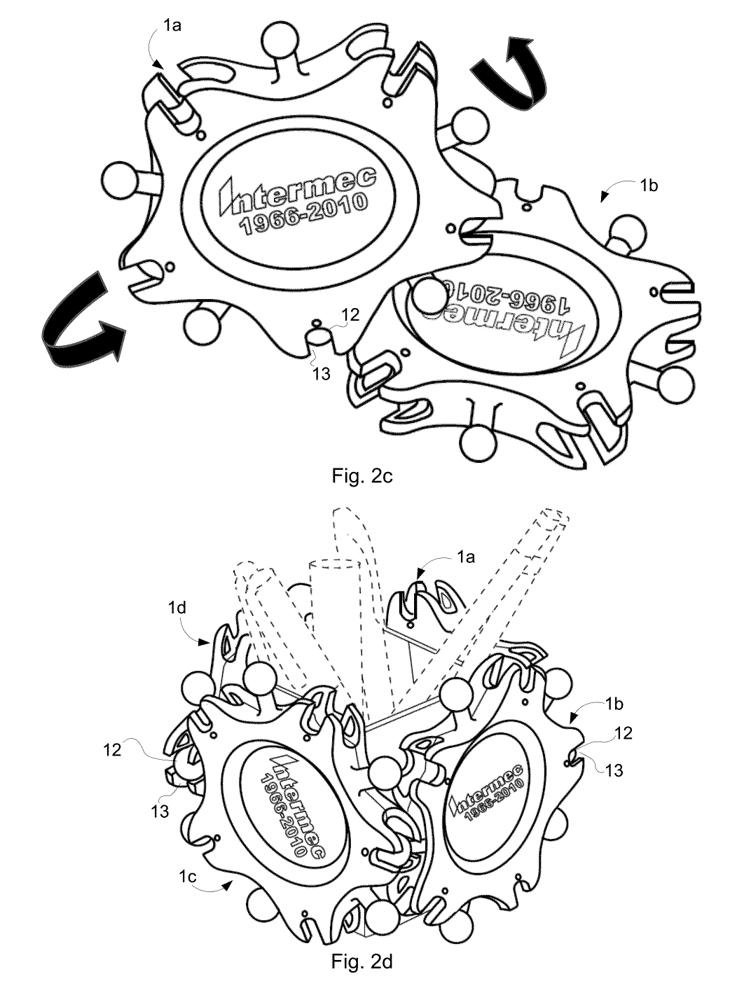

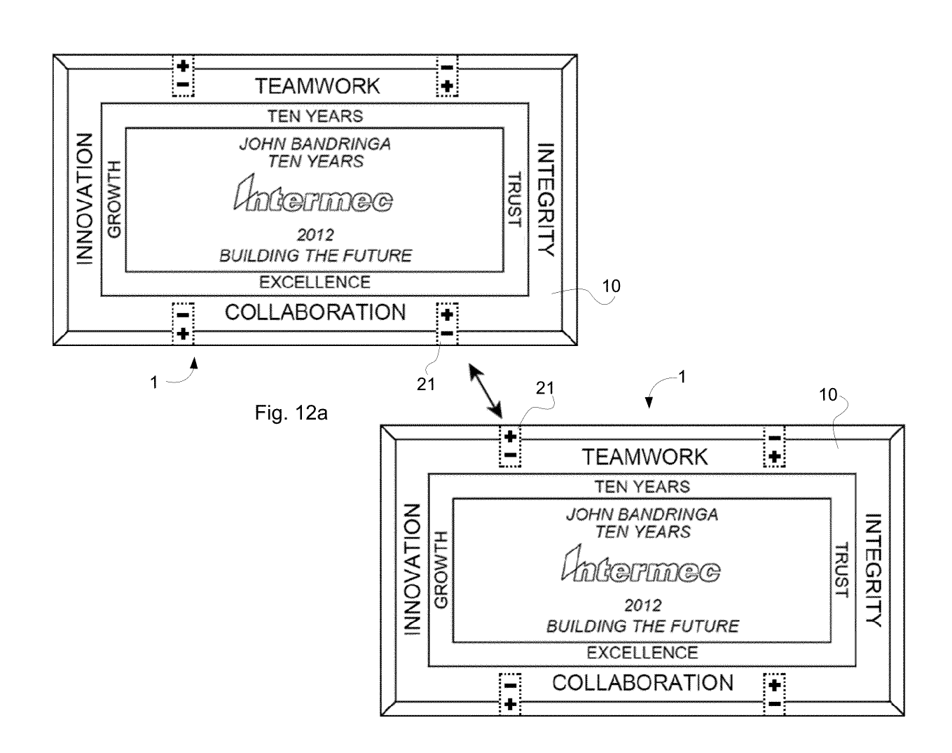

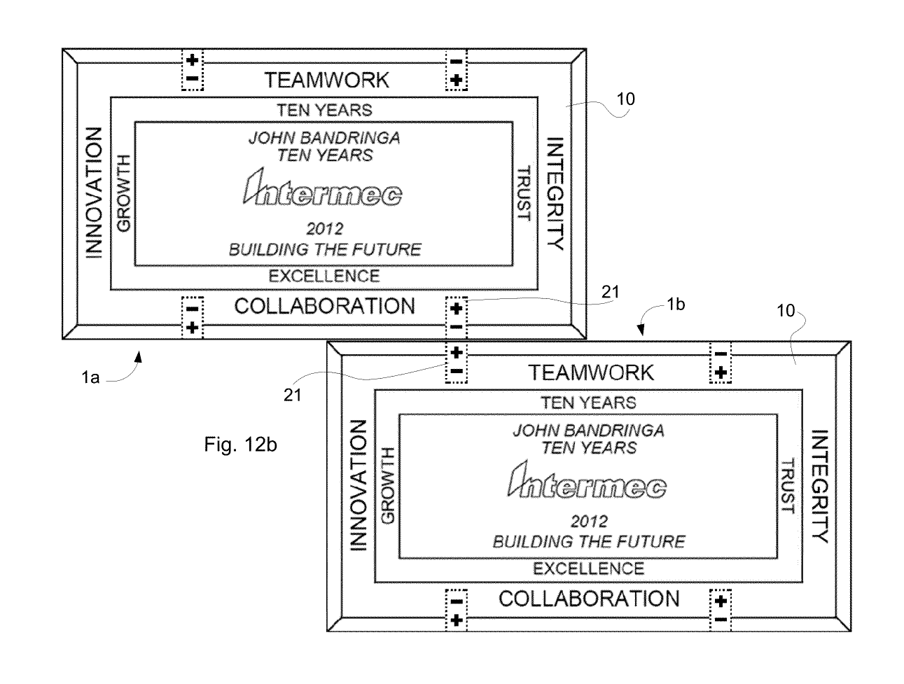

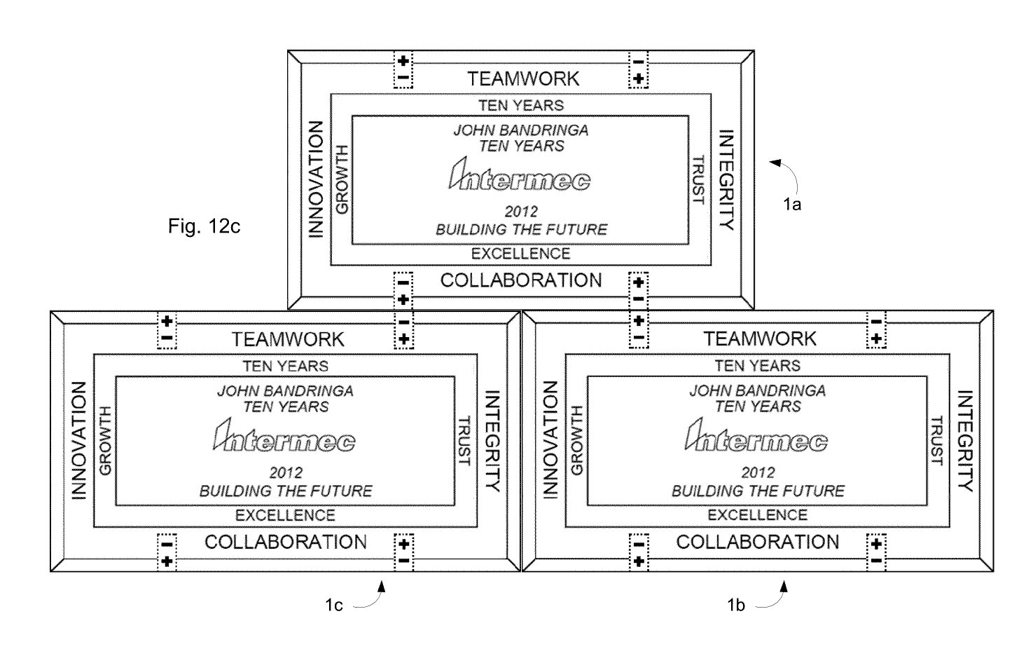

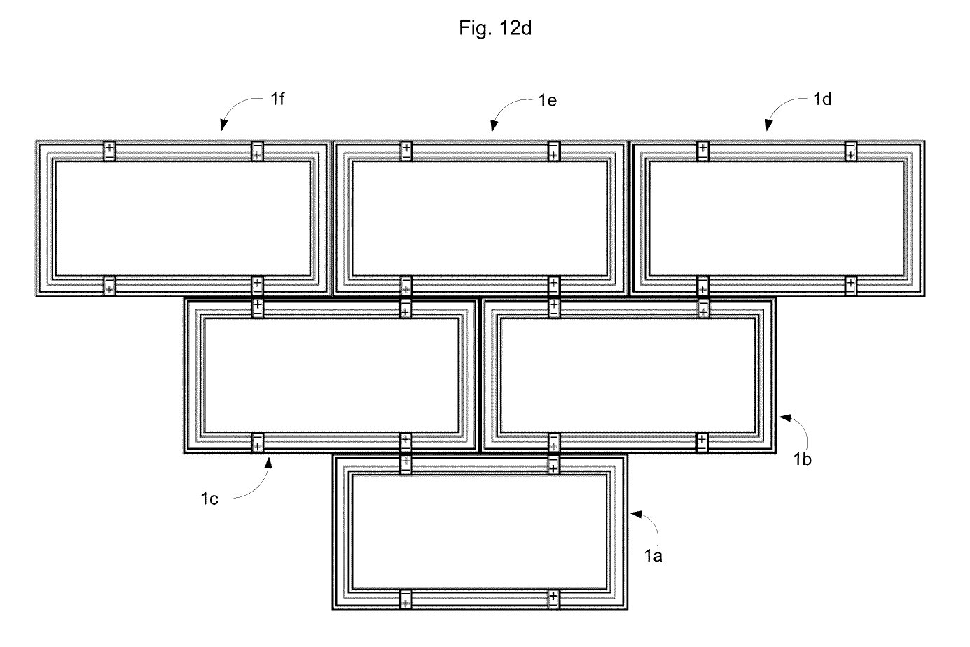

In some embodiments, an ornament 1 is configured for coupling with another ornament 1, such that a plurality of ornaments may be coupled together to form a whole. In some embodiments, the ornaments are configured for removably coupling with one another. In some embodiments, the coupling may be accomplished by pushing ornaments together using features of the ornament as may be seen in FIGS. 2a and 2b and FIGS. 12a-12d. The features of the ornament may also facilitate removing ornaments from the coupling, permitting the ornaments to be connected and disconnected. In some embodiments, the coupling and de-coupling (connecting and disconnecting) may be accomplished by hand with a light amount of force. In other embodiments, the coupling is semi-permanent or permanent. In different embodiments, the coupling and de-coupling may require hand tools, adhesives, solvents, or other means of making or breaking a more permanent connection. In different embodiments, the ornaments may slide into place and be connected such that only the force of gravity holds them together.

In some embodiments, an ornamental member 10 has one or more protrusions 11 extending from the ornamental member, the one or more protrusions having a ball 12 at an end of a protrusion opposite the ornamental member, for example in the embodiment depicted in FIGS. 1a and 1b. In some embodiments, an ornamental member has one or more sockets 13, the socket configured for removably receiving a ball of a different ornament. The socket may be configured such that two ornaments may be pushed together by inserting a ball of a first ornament in a socket of the second ornament and lightly pushing them together, such that a ball snaps into place in the socket. The ornament may be constructed so that portions of the socket deflect slightly, permitting the ball to pass into the socket, with the portions of the socket returning into position once the ball is snapped into the socket. The ornaments may be pulled apart using a light force, sufficient to deflect the portions of the socket that grip the ball and allowing the ball to pass out of the socket. The socket may be configured for receiving the ball by having a prong portion of the socket that slightly overlaps the ball for retaining the ball when the ball is resident in the socket.

In some embodiments, different components of the ornament are configured with a coupling mechanism for coupling to another ornament. The decorative element or snap-in ring may, for example, provide the coupling mechanism.

In different embodiments, coupling of ornaments is achieved magnetically, for example in the embodiment depicted in FIGS. 11a and 11b, and FIGS. 17a-17d. In such embodiments, the ornamental member 10 may have one or more magnets embedded within the ornamental member 10, as may be seen in FIGS. 12a-12d. The magnets may be oriented within the ornamental member in positions permitting ornaments to couple with other ornaments by pushing them together. The ornaments may be pulled apart using a light force. In some embodiments, the ornaments 1a, 1b, 1c . . . 1n may be coupled to form a plurality of ornaments 100 (as may be seen in FIGS. 17a-17d or 12a-12d).

In some embodiments, as may be seen in FIGS. 1a and 1b, an ornament 1 may have one or more channels 14 disposed through the ornament. In some embodiments, the ornamental member of the ornament has a front face 16 and a rear face 17, where in the channel is disposed through the ornamental member. In some embodiments, the channel opens at an aperture disposed through the front face. In other embodiments, the channel opens at an aperture disposed through the rear face. In some embodiments, the channel has apertures in both the front and rear faces, such that the channel is configured for receiving string or wire or other objects or means to pass completely through the ornament, which may in some embodiments include a means for mounting the ornament to a structure. In some embodiments, a front aperture is configured for receiving a gem, or a shaft of a pin.

In still other embodiments, removable coupling of ornaments is achieved through tabs and slots, for example in the embodiment depicted in FIG. 18a. In yet other embodiments, ornaments are coupled, removably or otherwise, using fasteners, threaded fasteners, notches, knobs, snaps, latches, grooves, studs, hollows, string, thread, rope, cable, wire, adhesives, joints, bonds, carriers, welds, melting, staples, tongue-and-groove, or other means of coupling.

In different embodiments, the ornament may have components which are made of differing materials, may be colored differently, may have varying degrees of transparency, and may have different properties such as a magnetic property, a particular tactile feel, or a particular odor or taste. In some embodiments, different ornaments may have different appearances or provide different sensations through selection of different ornamental members, decorative elements or snap-in rings that exhibit the different properties. For example, different colored snap-in rings might be available such that the decorative element is the same for every ornament, but that a blue or red snap-in ring could be selected for variety. Snap-in rings having different words may also be selected for variety, as could decorative elements having different designs. In one embodiment, the ornament is made of interchangeable ornamental members, decorative elements and snap-in rings, enabling an ornament to be customizable with respect to the varied ornamental members, decorative elements and snap-in rings. In some embodiments, at least a portion of the ornament is manufactured from material used in manufacturing a product distributed by an organization to non-employees of the organization. For example, an ornament may be an employee achievement award distributed by a company, wherein the ornaments are manufactured of a material predominant in manufacturing of a product sold by the company.

FIGS. 2a, 2b, 2c and 2d are a top view, a top view, a perspective view and a perspective view, respectively, of a plurality of couplable ornaments, in accordance with an embodiment of the invention. FIGS. 12a, 12b, 12c and 12d are various top views of pluralities of couplable ornaments, in accordance with an embodiment of the invention. In some embodiments, a plurality of ornaments 1 can be coupled. In some embodiments, such as the embodiment depicted in FIGS. 2a-2d, the ornament comprises a ball-and-socket construction for removably coupling a first ornament with at least a second ornament. In some embodiments, the ball-and-socket construction is configured for a first and a second coupled ornament to at least one of rotate, swivel, pivot or articulate relative to one another. As may be seen in FIG. 2b, an ornament 1a may be rotated about an axis AA which extends from the mated ball and socket (the ball 12 of ornament 1a and socket 13 of ornament 1b) through an axis disposed longitudinally through the protrusion 11 of ornament 1a and through the center of the ornament 1a. As may be seen in FIG. 2c, the ornament 1a may also swivel or pivot or articulate in different directions and rotations relative to the ornament 1b. A plurality of ornaments may be joined together as is shown in FIG. 2d, permitting structures or other designs to be constructed using the ornament (here, four ornaments 1a-1d surrounding a pencil cup holding writing instruments and other office tools).

In different embodiments, such as the embodiment depicted in FIGS. 12a-12d, the ornaments removably couple and de-couple through the use of one or more magnets 21 embedded within the ornamental member 10, each magnet configured for removably coupling a first ornament with at least a second ornament. For example, the magnets may be configured as depicted in dashed lines in FIGS. 12a-12c. The magnets may be embedded in any location in the ornamental member facilitating coupling ornaments with other ornaments. In one embodiment, an ornament 1 may have a generally rectangular appearance, with magnets 21 embedded along the top edge and bottom edge of the ornamental member 10 at ¼ and ¾ lengths across the bottom and top edges, with alternating positive and negative polarities of the embedded magnets. In this fashion, the ornaments may couple in a pyramid configuration, as can be seen in FIGS. 12b-12d. Other magnet position and polarity configurations are possible for providing different coupling mechanisms for the ornaments, and all such positions and configurations are within the scope of the instant disclosure. In different embodiments, the magnets are embedded within a different component (i.e. the decorative element or the snap-in ring) of the ornament. In still other embodiments, the magnets are at least partially exposed or are on a surface of the ornament.

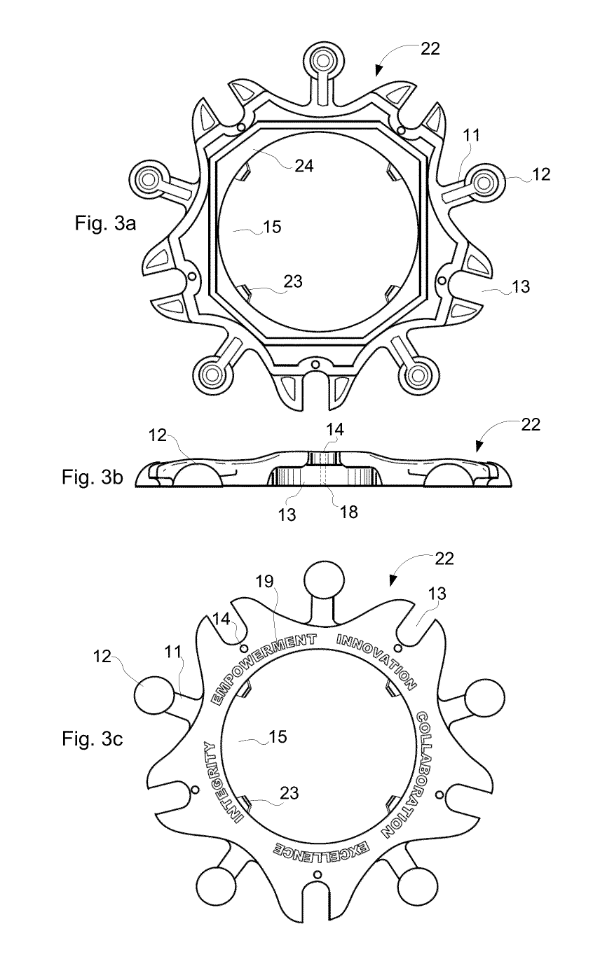

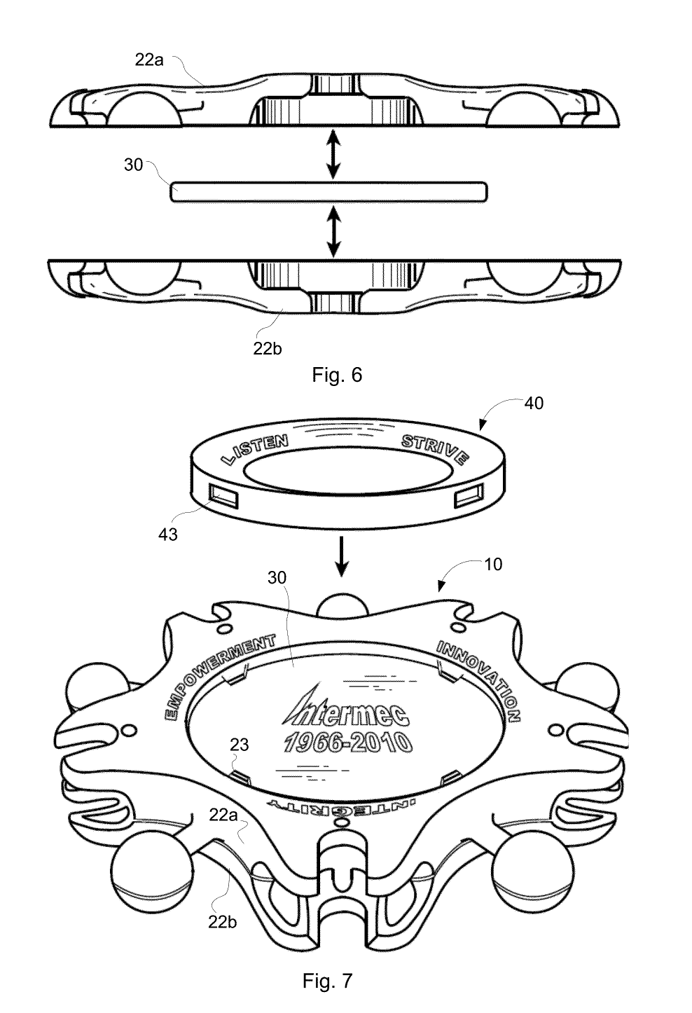

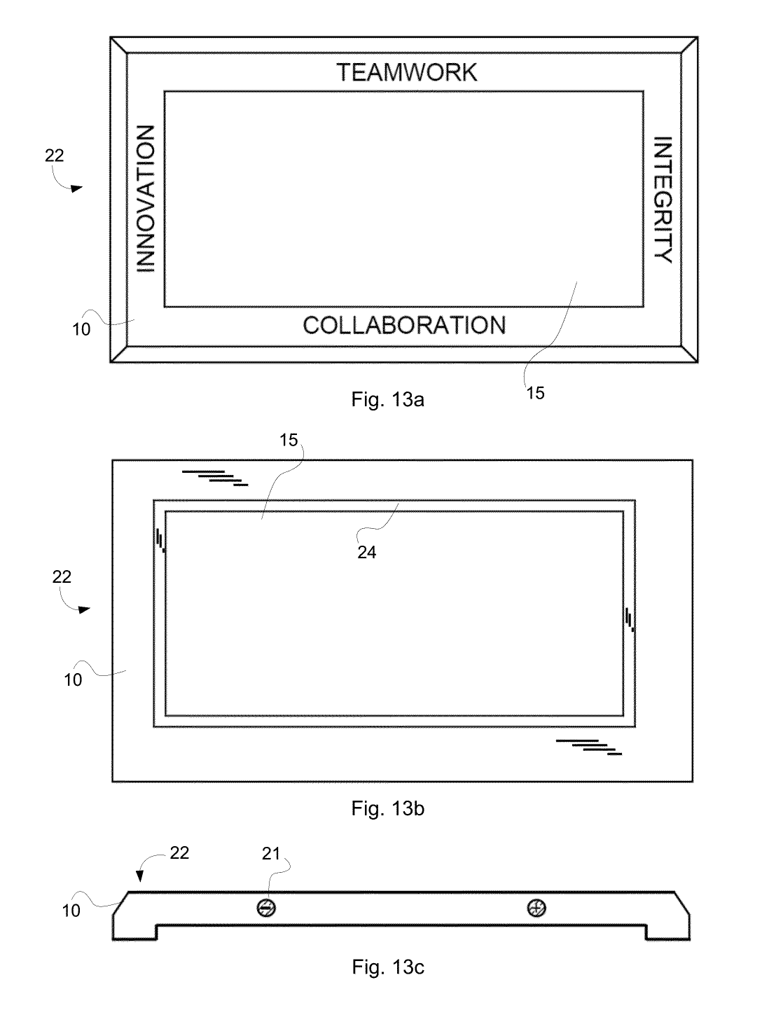

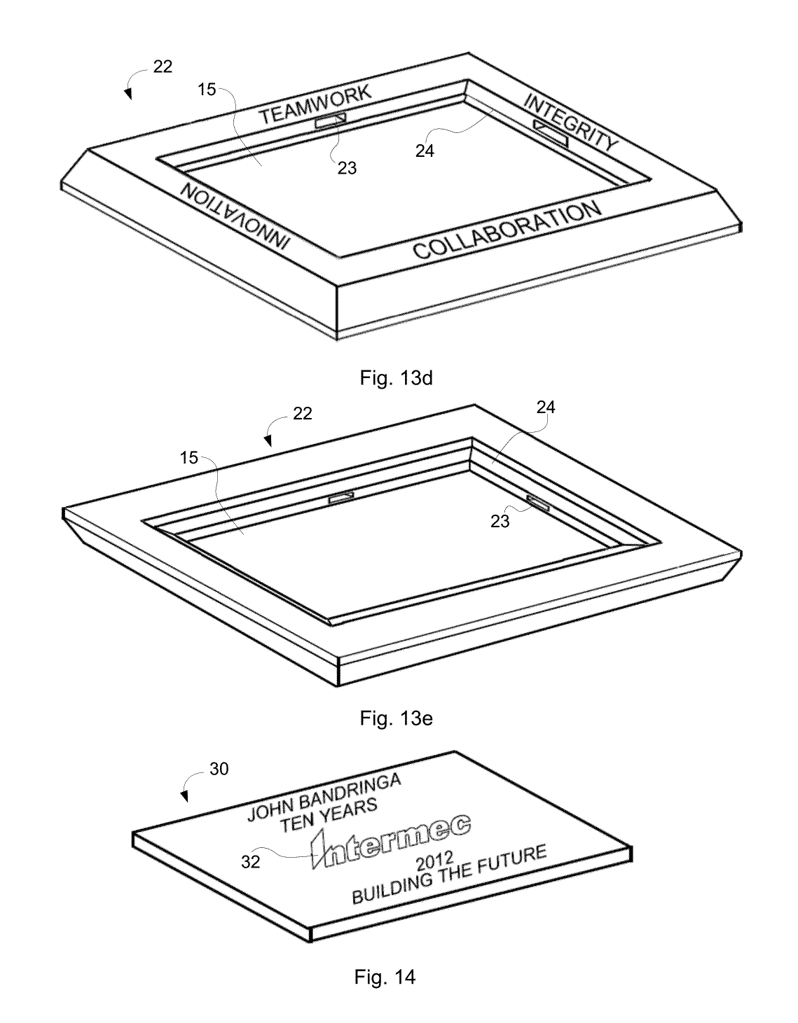

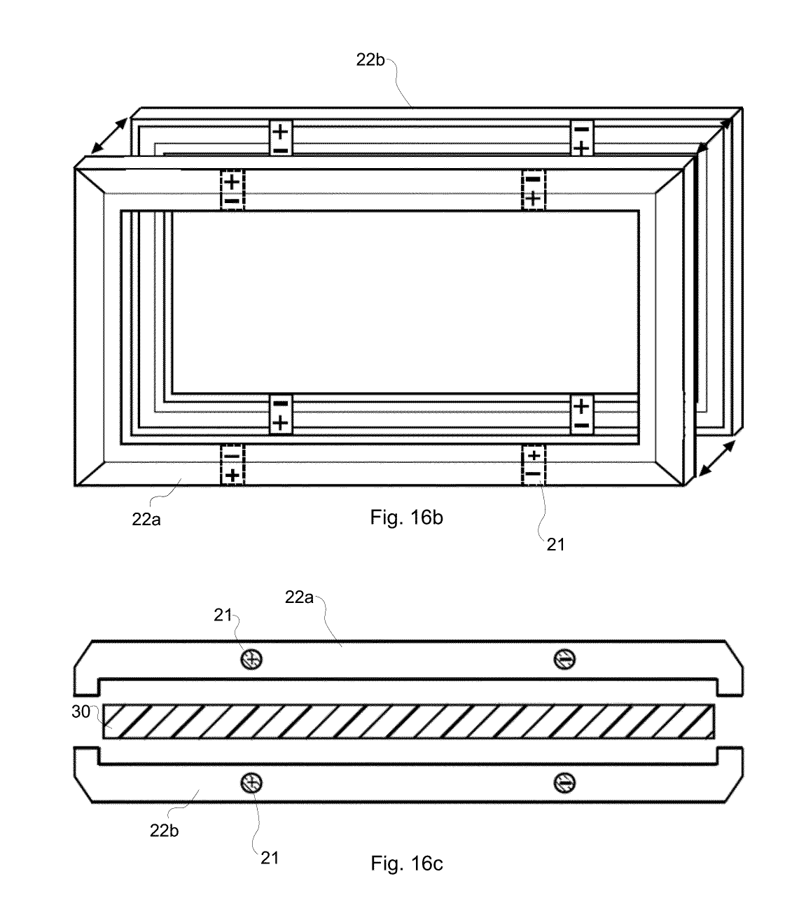

FIGS. 3a, 3b and 3c are a bottom view, a side view and a top view of a half of an ornamental member of a couplable ornament, in accordance with an embodiment of the invention. FIGS. 13a, 13b, 13c, 13d and 13e are a front view, a rear view, a cutaway side view, a front perspective view and a rear perspective view of a portion of an ornamental member, in accordance with an embodiment of the invention. In some embodiments, an ornamental member is comprised of two halves of the ornamental member 22. (In drawings depicting an individual half of the ornamental member, such as FIGS. 3a and 13a, the item is numbered 22. In drawings showing two halves of the ornamental member together forming an ornamental member 10, the halves are numbered 22a and 22b, as shown in FIGS. 1b and 11b.) In some embodiments, two halves of the ornamental member are coupled together with a decorative element 30 sandwiched in between the halves, as can be seen in FIGS. 6 and 16a.

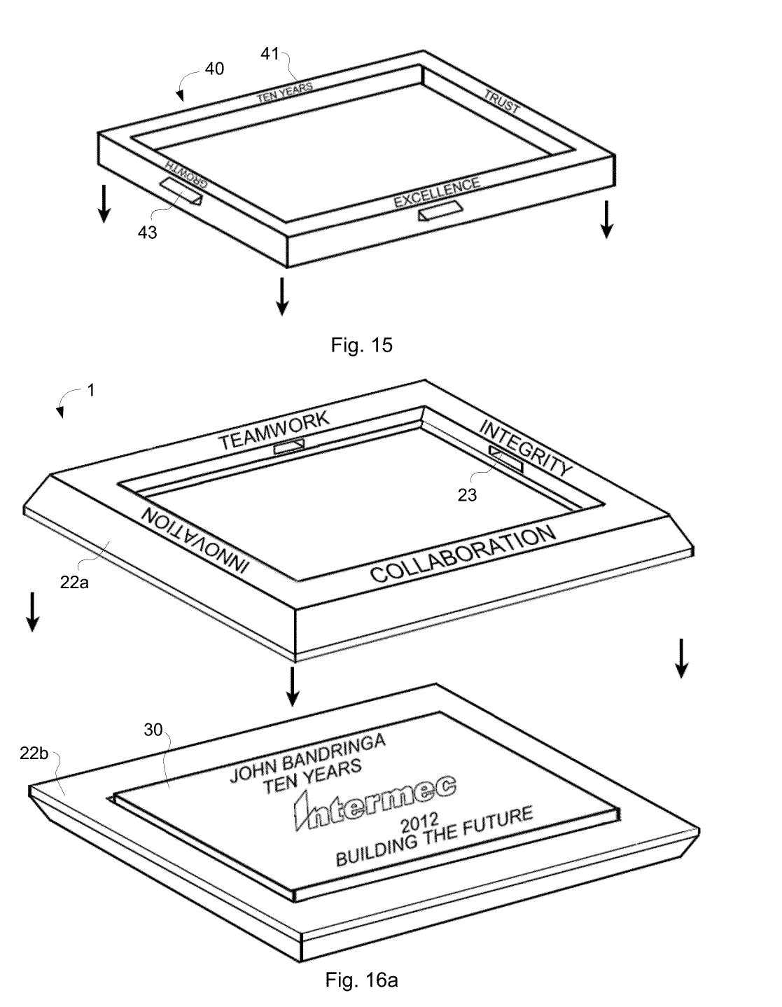

Returning to FIGS. 3a and 13a, in some embodiments, the half of an ornamental member 22 has an interior region 15 through which a portion of a decorative element may be seen after final construction of the ornament. In some embodiments, the rear face of the half of an ornamental member may have a channel 24 for receiving a portion of a decorative element. In some embodiments, the halves of the ornamental member may have one or more prongs or recesses 23, the prongs or recesses for facilitating coupling of a snap-in ring 40 (as may be seen viewing FIGS. 7 and 15). In some embodiments, the half of the ornamental member has a prong, where the snap-in ring would have a recess (as may be seen, for example, in the embodiment depicted in FIGS. 3b and 5a). In different embodiments, the half of the ornamental member has a recess, and the snap-in ring would have a prong (as may be seen, for example, in the embodiment depicted in FIGS. 13d and 15). In some embodiments, the ornament 1 has only a single snap-in ring in the front face of the ornament. Even though the rear half of the ornamental member may have prongs or recesses for coupling a snap-in ring to the rear face of the ornament, a snap-in ring is not required to be coupled with the rear face. In an alternative embodiment, one half of the ornamental member has prongs or recesses for facilitating coupling of a snap-in ring, and the other half does not.

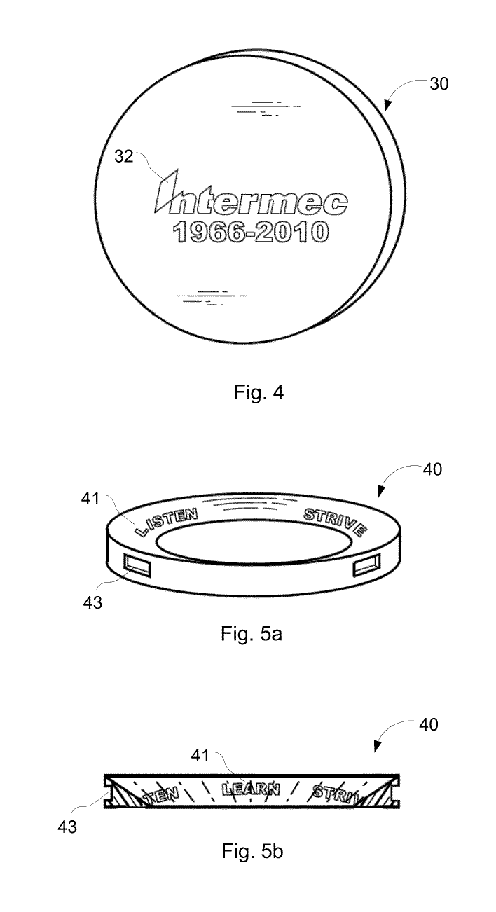

FIGS. 4 and 14 are perspective views of decorative elements of a couplable ornament, in accordance with different embodiments of the invention. As has been previously described elsewhere herein, in some embodiments a decorative element 30 is sandwiched between halves of the ornamental member. As has been previously described elsewhere herein, in some embodiments, the decorative element has a design 32, which may be a graphic design, words, images or other visually appealing element or elements. As has been previously described elsewhere herein, in some embodiments the decorative element is a substrate, or is a surface on which the design may be printed, screen, engraved, embedded, or otherwise applied using other processes disclosed elsewhere herein or with any other process.

FIGS. 5a and 5b are a perspective view and a cutaway side view of a snap-in ring of a couplable ornament, in accordance with an embodiment of the invention. FIG. 7 is an exploded view of a couplable ornament, in accordance with an embodiment of the invention. FIG. 15 is a perspective view of a snap-in ring of a couplable ornament, in accordance with an embodiment of the invention. As has been previously described elsewhere herein, in some embodiments a snap-in ring may have words 41, or a design or other visually appealing element, which may be formed and applied in any manner disclosed herein. In some embodiments, a snap-in ring may have a beveled appearance along the interior of the ring, as can be seen in FIGS. 5a and 5b. In different embodiments, a snap-in ring may, upon being inserted in the ornamental member, have a front face that is flush with the front face of the ornamental member, as can be seen in FIG. 15 or 11b. In some embodiments, a snap-in ring may snap into place using one or more prongs and/or recesses, wherein the prongs or recesses are disposed along the sides of the snap-in ring and one or more surfaces adjacent to the interior region of the ornamental member.

FIG. 6 is an exploded view of a couplable ornament, in accordance with an embodiment of the invention. FIGS. 16a, 16b and 16c are various exploded views of portions of a couplable ornament, in accordance with an embodiment of the invention. In some embodiments, a decorative element 30 is sandwiched between two halves of the ornamental member 22a and 22b. In some embodiments, the decorative element is thus fastened to the ornamental member. Accordingly, in some embodiments, the decorative element is at least partially embedded within an interior region of the ornamental member. Upon sandwiching the two halves of the ornamental member and decorative element together, the two halves of the ornamental member are joined, perhaps with sonic welding, glue, or other means of adhering or coupling the halves with the decorative element in between. FIG. 16b shows two halves of the ornamental member, 22a and 22b, being pressed together, and also depicts the magnets 21 embedded within the ornamental member. Particularly, as has been disclosed elsewhere herein, the magnets are placed at ¼ and ¾ lengths across the top and bottom of the ornamental member. FIG. 16b shows that the polarities of the magnets of each of the two halves, 22a and 22b, that are adjacent to one another have the same orientation, such that a positive pole lines up next to another positive pole. FIG. 16c is a cross-sectional view of the side of the sandwiched halves 22a and 22b and the decorative element 30, with the cross-sectional slice through the magnets 21 being shown, again showing the polarity of the adjacent magnets lining up next to one another. During assembly of the two halves, the halves will repel one another due to the magnetic force, until the halves are adhered and coupled. However, once the halves are coupled, the pair of magnets from adjacent halves will have a tendency to attract other ornaments.

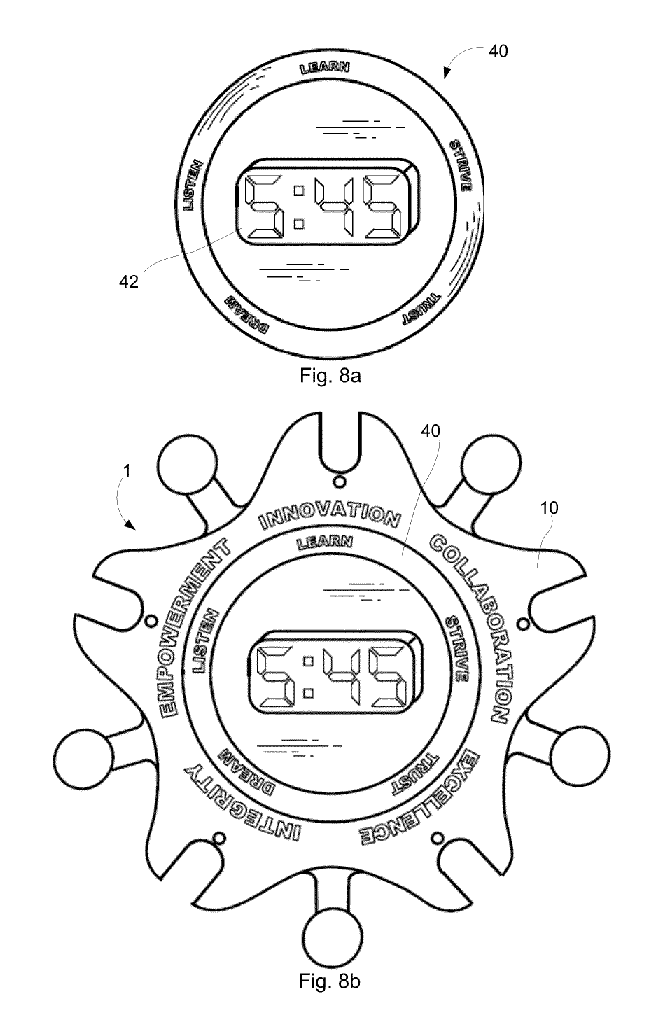

FIGS. 8a and 8b are a top view of an alternate embodiment of a snap-in ring and a top view of an alternate embodiment of a couplable ornament, in accordance with an embodiment of the invention. In some embodiments, a snap-in ring 40 may have an element different than or in addition to a design, such as a clock 42. In different embodiments, a snap-in ring may alternatively comprise a calendar, a pen holder, a dartboard, a picture frame, a compartment for storing items, a feeder, or other functional element. In some embodiments, one or more of the ornamental member or the decorative element may comprise the clock, calendar, dartboard, feeder, compartment or other functional element.

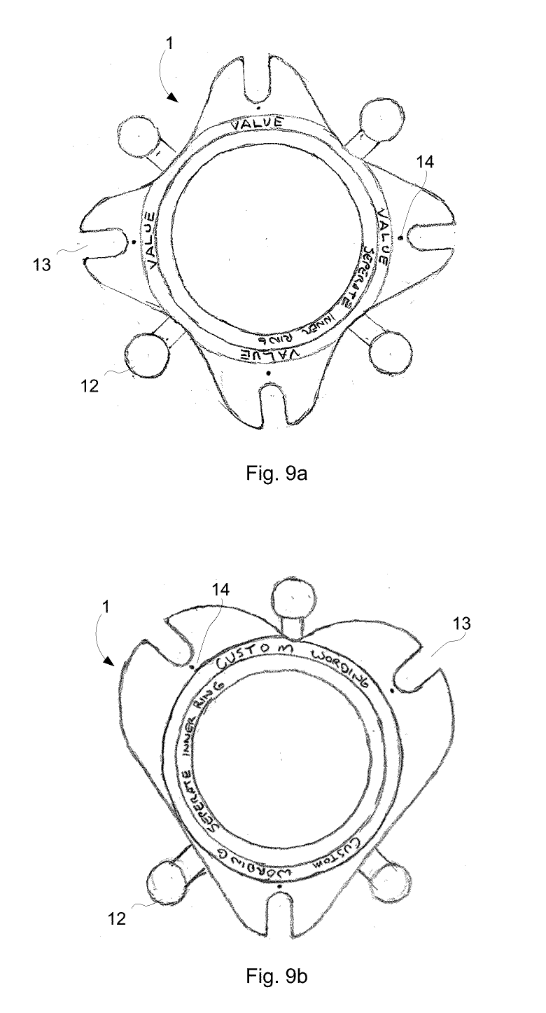

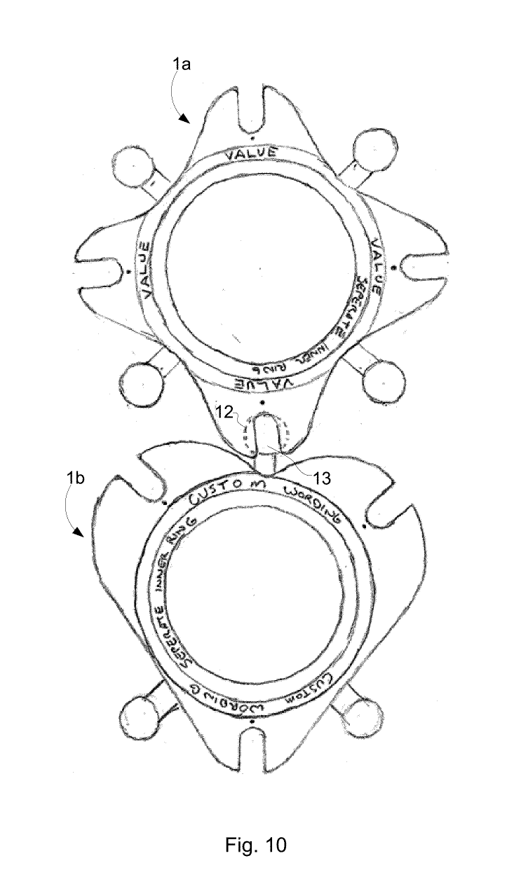

FIGS. 9a and 9b are top views of alternate embodiments of a couplable ornament, in accordance with embodiments of the invention. FIG. 10 is a top view of coupled alternate embodiments of a couplable ornament, in accordance with embodiments of the invention. As has been previously discussed elsewhere herein, in some embodiments, an ornament 1 may be substantially in the shape of a four-pointed star, a heart, or another geometric shape. In some embodiments, similarly-shaped ornaments couple with other similarly-shaped ornaments. In different embodiments, differently-shaped ornaments may have the same coupling means, including a ball-and-socket coupling means. In some embodiments, differently-shaped ornaments may couple to one another using the same coupling means.

FIG. 18a is a perspective view of a plurality of couplable ornaments, in accordance with an embodiment of the invention. In some embodiments, a couplable ornament 1 (the three ornaments in FIG. 18a shown as 1a, 1b, and 1c) may be substantially flat. The ornament may have faces that are outwardly facing, such as face 16 and face 17. The faces may be opposing one another. In some embodiments, the faces may include a front face (e.g. front face 16) and a rear face (e.g. rear face 17). In other embodiments, the faces may include a first face (e.g. first face 16) and a second face (e.g. second face 17). In still other embodiments, the faces may include an obverse face (e.g. obverse face 16) and a reverse face (e.g. reverse face 17). In some embodiments, an edge may circumscribe the ornament, such as edge 27 which extends around the sides of the ornament between the first face and second face.

In some embodiments, the couplable ornament 1 includes an attachment arrangement configured for enabling couplable ornaments to removably couple from one another. As previously discussed with respect to other figures, ornaments are coupled, removably or otherwise, using tabs and slots, fasteners, threaded fasteners, notches, knobs, snaps, latches, grooves, studs, hollows, string, thread, rope, cable, wire, adhesives, joints, bonds, carriers, welds, melting, staples, tongue-and-groove, or other means of coupling. An embodiment depicted in FIG. 18a shows a tab and slot arrangement, wherein a slot 25 engages with a tab 26. In some embodiments, the slot includes a cutout through the edge 27 of the ornament. The tab, which is inserted into the slot to couple adjoining ornaments, may include an edge of the ornament. The edge of the ornament comprising the tab may include an edge which is defined by the interior portion of the cutout 26a, or may include an edge not associated with a cutout 26b. The ornaments may couple when a slot portion of an ornament receives an edge portion of a second ornament, including either a cutout portion of the second ornament with the edge 26a engaging the ornament, or an edge portion 27 of the second ornament not associated with a cutout.

FIG. 18b is a perspective view of a plurality of couplable ornaments, in accordance with an embodiment of the invention. In some embodiments, a couplable ornament 1 (including ornaments in FIG. 18b shown as 1a, 1b, and 1c) may have different shapes. For example, the ornaments in FIG. 18a have a rectangular profile, while the ornaments in FIG. 18b have a circular profile. Other profiles are possible, including geometric profiles such as a square, an oval, a triangle, a hexagon, a trapezoid, etc. Other profiles may be irregular, asymmetric, or be shaped like an object. For example, an ornament may have a profile shaped like a heart (as shown in FIG. 9b), a car, a building, a person, an airplane, a telephone, an animal, etc. Differently-shaped ornaments may also couple together, as shown in FIG. 10. As discussed elsewhere, an ornament may have a decoration. Shown in FIG. 18b is a star 32 in dashed lines. The star is exemplary only; any design is possible. The design may be screened onto a face of an ornament, may be milled into the face of the ornament, may be included on a layer which is adhered to the face of the ornament, or may be placed onto the ornament using any other process providing a decoration visible from the outside of the ornament. In some embodiments, a portion of the ornament is clear with the decoration embedded into the ornament and visible from the outside through the clear portion of the ornament. In some embodiments, the decorative element is associated with a first, front, or obverse face of the ornament. In some embodiments, the second, rear, or reverse face of the ornament is not associated with a decorative element. In other embodiments, a decorative element is present on both a first face 16 and a second face 17 of the ornament.

As discussed in relation to FIG. 18a, an ornament may have a cutout 25 through an edge 27 of the ornament. The cutout may have at least one rounded corner 28a at a junction of the edge and the cutout or slot. In some embodiments, two rounded corners 28a and 28b are present, one on either side of the cutout or slot at junctions with the edge. The rounded corners may facilitate insertion of a tab or edge of a second ornament into a slot or cutout of a first ornament.

In some embodiments, an ornament may have a sandwich construction including an inner layer 35 and one or more outer layers, for example outer layers 34a and 34b disposed on opposing sides of the inner layer. In different embodiments, additional outer layers are possible (e.g. a five layer construction having an inner layer with some combination of outer layers—two outer layers to each side of the inner layer, or one outer layer on one side of the inner layer and three outer layers on the other side of the inner layer).

FIGS. 18c and 18d are a top view and a side view of an ornament, in accordance with an embodiment of the invention. As discussed previously, an ornament 1 may have a first face 16 and a second face 17, the first and second faces on opposing exterior portions of the ornament. The ornament may include a sandwich construction with at least two layers 34a and 35. In some embodiments, a third layer 34b may be present, whereby layers 34a and 34b are outer layers and layer 35 is an inner layer. In some embodiments, layer 35 may be a compressible layer. The compressible layer may be made of a soft material, or a semi-rigid material. The compressible layer may compress under tension, when being squeezed, for example. In some embodiments, compressible layer 35 is an inner layer between two outer layers 34a and 34b. In different embodiments, the compressible layer 35 may be disposed adjacent to an additional single layer. The additional single layer may be compressible, may be not compressible, or may compress differently (i.e. require more or less force to compress).

In some embodiments, a cutout 25 is present through all layers of the ornament. The cutout 25 may include rounded corners 28a and 28b at a junction of the cutout and the edge 27 of the ornament.

FIG. 18e is a side view of an ornament, in accordance with an embodiment of the invention. In some embodiments, the ornament may include a compressible layer 35 and another layer 34. In some embodiments the another layer is compressible, is not compressible, or may compress differently than compressible layer 35 (i.e. require more or less force to compress). In some embodiments, a first face 16 may be an exterior face of layer 34. In some embodiments, a second face 17 may be an exterior face of layer 35. In some embodiments, a decorative element will be at least one of present on the first face 16 or embedded within layer 34 and visible through a clear portion of layer 34. In other embodiments, a decorative element may be embedded between layers 34 and 35 and be visible through one or more clear portions of layers 34 or 35. Importantly, a thickness of the ornament in FIG. 18e measured through the sandwiched compressible layer 35 and second layer 34 may be the same as the thickness of a three-layer ornament.

FIG. 18f is a side view of an ornament, in accordance with an embodiment of the invention. As discussed previously, ornament 1 may have a compressible center layer 35 disposed between outer layers 34a and 34b. When the sides of the ornament are squeezed inward (represented by the arrows to the right of FIG. 18f, one representing force coming from the top of the ornament and one representing force coming from the bottom of the ornament), the compressible layer will compress. The outer layers will either not compress, will compress slightly, or will compress slightly near where the force is being applied.

FIGS. 18g, 18h, and 18i are top views of an attachment arrangement configured for removably coupling ornaments, in accordance with an embodiment of the invention. In these views, two ornaments 1a and 1b are shown being coupled via the attachment arrangement. The attachment arrangement may be operable via a tab or an edge of an ornament (the tab or edge of the ornament including the edges of layers 34a, 34b, and 35) such as ornament 1a being inserted into a slot or cutout (the slot or cutout including cutout 25 having rounded corners 28a and 28b) of a second ornament such as ornament 1b. As may be seen in FIG. 18g, the thickness of the ornament through layers 34a, 34b, and 35 may be slightly larger than the width of the cutout (the width not including the rounded corners). Further, the width of the cutout including the rounded corners is approximately the same size as the thickness of the ornaments. When an edge of a first ornament is inserted into a cutout of a second ornament, a portion of the first ornament may deflect or compress in order to fit into the cutout of the second ornament. The compression force exerted by the sides of the cutout of the second ornament on the outsides (i.e. the first face and second face) of the first ornament may tensionally bias the ornaments to hold together.

In different embodiments, the width of the cutout is greater than the thickness of the ornament and no tensional bias is present, the ornaments held together through gravity, glue, fasteners, or other means. This may be seen, for example, in FIG. 18m.

As may be seen in FIG. 18h, when an edge of a first ornament (i.e. the ornament on the left side of the figure) is inserted into the cutout of the second ornament (i.e. the ornament on the right side of the figure), the rounded corners of the cutout will begin to compress the first ornament. As force is applied from the left pushing the first ornament into the cutout of the second ornament (said force represented by the arrow to the left of the first ornament in FIG. 18h), the first ornament will compress further as the cutout exerts compressive forces on the sides of the first ornament (said compressions forces represented by the arrows above and below the first ornament in FIG. 18h). As shown in FIGS. 18h and 18i, the compression results from the soft, semi-rigid compressible layer 35, while outer layers 34a and 34b may be made of a non-compressible (or less compressible) material that do not deflect or compress to the same degree as the center layer.

In some embodiments, the sides of the cutout are parallel, or U-shaped with the edge of the ornament forming the open top of the U. In different embodiments, the sides of the cutout are angled outwards in a V-shape, with the edge of the ornament forming the open top of the V. In some embodiments, the portion of the cutout in the center of the second ornament which may engage the edge of the first ornament is flat, while in other embodiments it is rounded or takes another shape.

As may be seen in FIG. 18i, upon the first ornament being pushed all the way into the cutout, the edge of the first ornament rests against the interior edge of the cutout of the second ornament. The compressive forces exerted by the compressible layer of the first ornament against the inner sides of the outer layers (i.e. first layer and second layer) of the first ornament, the forces being transmitted through the outer layers and received by the sides of the cutout of the second ornament, are sufficient to hold the ornaments together.

However, the ornaments are removably couplable in that the ornaments may be pulled apart by hand. Upon being separated, the compressible layer will return to its original shape. Accordingly, the attachment arrangement including the tab and slot (edge and cutout) is configured for compressibly removably coupling two ornaments.

In embodiments having only two layers (e.g. a compressible layer and a second layer sandwiched together) such as the ornament shown in FIG. 18e, the thickness of the two-layer ornament may be the same as three-layer ornaments so that the compressible layer of the two-layer ornament still compresses to compressibly removably couple with a second ornament via the cutout of the second ornament.

FIG. 18j is a perspective view of an attachment arrangement for compressibly removably coupling a first ornament with a second ornament. The figure depicts ornaments 1a and ornament 1b being compressibly removably coupled together where the slots of ornaments 1a and 1b engage one another, and the compressible layers of both ornaments compress. It is also possible to insert an edge of a first ornament into a slot of a second ornament where the inserted edge of the first ornament is not associated with a slot of the first ornament (not depicted in FIG. 18j). The coupling is not as strong in the foregoing coupling because only the compressible layer of the first ornament will compress; however, the ornaments would still compressibly removably couple. When a slot of a first ornament is engaged with a slot of a second ornament and both ornaments compress at the compressible layer, the coupling is tighter because there is compressive force applied against the inside edges of both cutouts.

Returning to FIG. 18b, it may be seen that multiple slots of a single ornament may receive multiple other ornaments. It will be understood that different portions of the compressible layer associated with the multiple slots or cutouts may all compress when engaging slots of the multiple other ornaments.

As may be seen in FIGS. 18a through 18j, the slot defined by the cutout of the ornament through the edge is cut out at a substantially right angle to the edge, such that the ornaments are orthogonal to one another when coupled. (Substantially in this instance meaning 90 degrees or at an angle which is not visibly perceptibly different from 90 degrees when viewed with the naked eye and/or without the aid of measurement tools.) In these embodiments, upon a first ornament being inserted into the second ornament, an invisible plane through the center layer of the first ornament is orthogonal to an invisible plane through the center layer of the second ornament. However, the cutout may be other than 90 degrees from the edge.

FIG. 18k is a front view of an ornament, in accordance with an embodiment of the invention. FIG. 18m is a perspective view of two coupled ornaments, in accordance with an embodiment of the invention. As described above, a cutout may be at other than a 90 degree angle from the edge. For example, FIG. 18k depicts the cutout being angled to the left relative to 90 degrees from the edge. The result would be as shown in FIG. 18m, whereby a first ornament 1a inserted into a second ornament 1b would be at an angle other than a perpendicular angle relative to the second ornament. In other words, a plane through the first ornament 1a would not be orthogonal to a plane through the second ornament 1b. This may be done for variety, providing the ability to couple ornaments in different assembly configurations. It is envisioned that ornaments such as that depicted in FIG. 18k could couple with ornaments such as that depicted in FIG. 18c (i.e. with ornaments having a cutout at a 90 degree angle to the edge of the ornament).

FIG. 18n is a front view of an ornament, in accordance with an embodiment of the invention. FIG. 18o is a perspective view of two coupled ornaments, in accordance with an embodiment of the invention. FIG. 18n depicts a cutout which is at a 90 degree angle to the edge, but that is twisted slightly across the width of the ornament. The result would be as shown in FIG. 18o, whereby a first ornament 1a inserted into a second ornament 1b would be at an angle other than a perpendicular angle relative to the second ornament. In other words, a plane through the first ornament 1a would not be orthogonal to a plane through the second ornament 1b. This may be done for still more variety, providing the ability to couple ornaments in additional and different assembly configurations. It is envisioned that ornaments such as that depicted in FIG. 18n could couple with ornaments such as that depicted in FIG. 18c (i.e. with ornaments having a cutout at a 90 degree angle to the edge of the ornament).

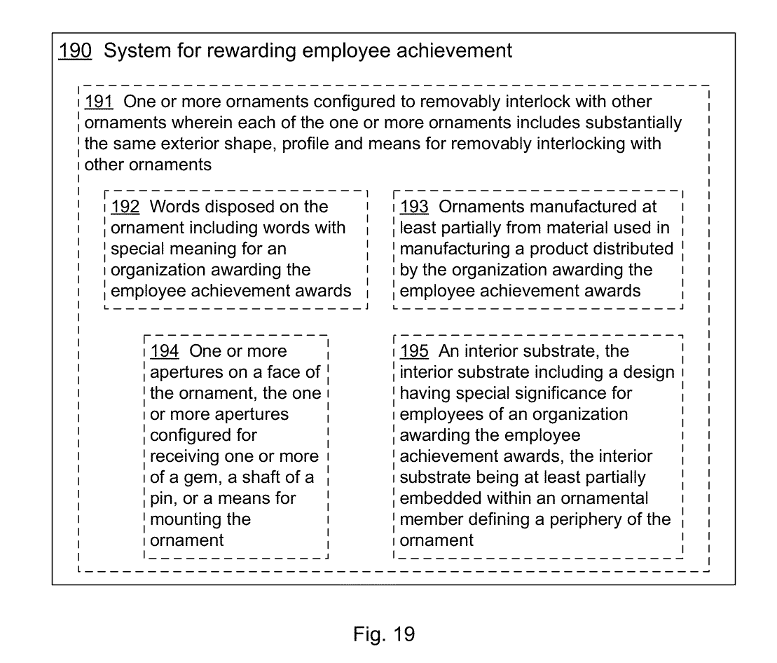

FIG. 19 is a system diagram of a system for rewarding employee achievement, in accordance with an embodiment of the invention. In some embodiments, a system for rewarding employee achievement 190 comprises one or more ornaments configured to removably interlock with other ornaments 191, wherein each of the one or more ornaments includes substantially the same exterior shape, profile and means for removably interlocking with other ornaments. In some embodiments, an ornament 191 may include at least words disposed on the ornament 192, the words including words with special meaning for an organization awarding the employee achievement awards. In some embodiments, an ornament 191 may include at least ornaments manufactured at least partially from material used in manufacturing a product distributed by the organization awarding the employee achievement awards 193. In some embodiments, an ornament 191 may include at least one or more apertures 194 on a face of the ornament, the one or more apertures configured for receiving one or more of a gem, a shaft of a pin, or a means for mounting the ornament. In some embodiments, an ornament 191 may include at least an interior substrate 195, the interior substrate including a design having special significance for employees of an organization awarding the employee achievement awards, the interior substrate being at least partially embedded within an ornamental member defining a periphery of the ornament.

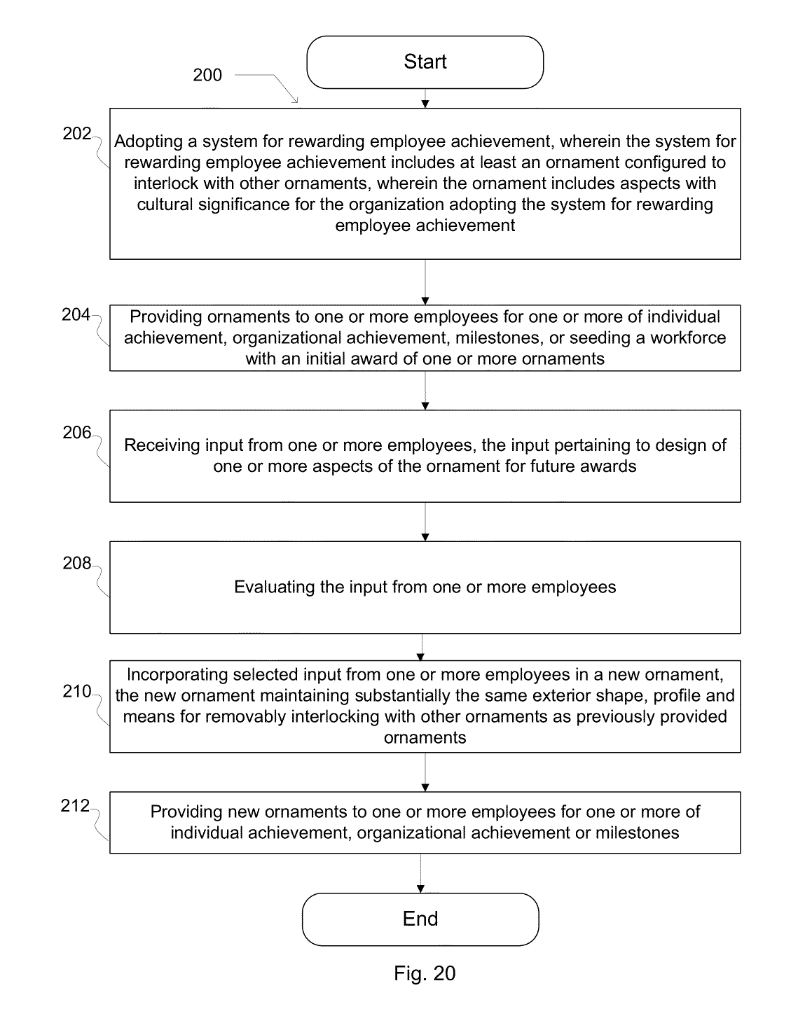

FIG. 20 is a flow diagram of a method for rewarding employee achievement, in accordance with an embodiment of the invention. In some embodiments, a method for rewarding achievement 200 may have an operation 202, an operation 204, an operation 206, an operation 208, an operation 210, and/or an operation 212. After a start operation, the method 200 moves to operation 202, which includes adopting a system for rewarding employee achievement, wherein the system for rewarding employee achievement includes at least an ornament 1 configured to interlock with other ornaments, wherein the ornament includes aspects with cultural significance for the organization adopting the system for rewarding employee achievement.

The method 200 may include an operation 204, which includes providing ornaments to one or more employees for one or more of individual achievement, organizational achievement, milestones, or seeding a workforce with an initial award of one or more ornaments.

The method 200 may include an operation 206, which includes receiving input from one or more employees, the input pertaining to design of one or more aspects of the ornament for future awards.

The method 200 may include an operation 208, which includes evaluating the input from one or more employees.

The method 200 may include an operation 210, which includes incorporating selected input from one or more employees in a new ornament, the new ornament maintaining substantially the same exterior shape, profile and means for removably interlocking with other ornaments as previously provided ornaments.

The method 200 may include an operation 212, which includes providing new ornaments to one or more employees for one or more of individual achievement, organizational achievement or milestones.

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. An ornament, comprising:
a first face;
a second face;
an edge circumscribing the ornament; and
an attachment arrangement configured for removably coupling the ornament to at least a second ornament.

2. The ornament of claim 1, wherein the attachment arrangement configured for removably coupling the ornament to at least a second ornament comprises:
the attachment arrangement configured for compressibly removably coupling the ornament to at least a second ornament.

3. The ornament of claim 1, wherein the attachment arrangement configured for removably coupling the ornament to at least a second ornament comprises:
the attachment arrangement configured for removably coupling the ornament to at least a second ornament, wherein at least a portion of the ornament or the at least a second ornament compresses upon coupling the ornament and the at least a second ornament.

4. The ornament of claim 1, wherein the attachment arrangement configured for removably coupling the ornament to at least a second ornament comprises:
the attachment arrangement configured for removably coupling the ornament to at least a second ornament, wherein at least a portion of the attachment arrangement of at least one of the ornament or the at least a second ornament deflects upon coupling the ornament and the at least a second ornament.

5. The ornament of claim 1, wherein the attachment arrangement configured for compressibly removably coupling the ornament to at least a second ornament comprises:
at least one slot defined by at least one cutout of the ornament through the edge, the at least one slot configured for removably receiving at least a second ornament.

6. The ornament of claim 5, wherein the at least one slot defined by a cutout of the ornament through the edge, the at least one slot configured for removably receiving at least a second ornament comprises:
the at least one slot defined by at least one cutout of the ornament through the edge, the at least one slot configured for removably receiving at least a second ornament via insertion of at least an edge of the at least a second ornament into the at least one slot.

7. The ornament of claim 5, wherein the at least one slot defined by a cutout of the ornament through the edge, the at least one slot configured for removably receiving at least a second ornament comprises:
the at least one slot defined by at least one cutout of the ornament through the edge, the at least one slot configured for removably receiving at least a second ornament via insertion of at least an edge of the at least a second ornament into the at least one slot, wherein the at least one slot includes a width smaller than a thickness of the at least a second ornament.

8. The ornament of claim 7, wherein the at least one slot defined by at least one cutout of the ornament through the edge, the at least one slot configured for removably receiving at least a second ornament via insertion of at least an edge of the at least a second ornament into the at least one slot, wherein the at least one slot includes a width smaller than a thickness of the at least a second ornament comprises:
the at least one slot defined by at least one cutout of the ornament through the edge, the at least one cutout including at least two rounded corners between the edge and the cutout, wherein the at least two rounded corners facilitate compressibly removably receiving at least a second ornament via insertion of at least an edge of the at least a second ornament into the at least one slot, wherein at least a portion of the at least two rounded corners compresses the at least a second ornament.

9. The ornament of claim 5, wherein the at least one slot defined by at least one cutout of the ornament through the edge, the at least one slot configured for removably receiving at least a second ornament comprises:
the at least one slot defined by at least one cutout of the ornament through the edge, the at least one cutout oriented at substantially a right angle to the edge of the ornament, the at least one slot configured for removably receiving at least a second ornament via insertion of at least an edge of the at least a second ornament into the at least one slot, the ornament bearing a fixedly orthogonal orientation to the at least a second ornament upon removably receiving the at least a second ornament via the right angle cutout.

10. The ornament of claim 9, wherein the at least one slot defined by at least one cutout of the ornament through the edge, the at least one cutout oriented at substantially a right angle to the edge of the ornament, the at least one slot configured for removably receiving at least a second ornament via insertion of at least an edge of the at least a second ornament into the at least one slot, the ornament bearing a fixedly orthogonal orientation to the at least a second ornament upon removably receiving the at least a second ornament via the right angle cutout comprises:
the at least one slot defined by at least one cutout of the ornament through the edge, the at least one slot configured for compressibly removably receiving at least a second ornament via insertion of at least an edge of the at least a second ornament into the at least one slot, wherein at least a portion of the at least a second ornament compresses upon coupling the ornament and the at least a second ornament.

11. The ornament of claim 1, wherein the attachment arrangement configured for removably coupling the ornament to at least a second ornament comprises:
the attachment arrangement including at least a ball and socket attachment arrangement configured for removably coupling the ornament to at least a second ornament, wherein at least a socket portion of the at least a second ornament deflects upon coupling the ornament and the at least a second ornament via insertion of a ball portion of the ornament into the socket portion of the at least a second ornament.

12. The ornament of claim 1, further comprising:
a first layer, the first face disposed on an outer side of the first layer;
a second layer, the second face disposed on an outer side of the second layer; and
a compressible layer, the compressible layer disposed in between an inner side of the first layer and an inner side of the second layer.

13. The ornament of claim 12, wherein the first layer comprises:
the first layer, wherein the first face is a decorative element adhered to the outer side of the first layer.

14. The ornament of claim 12, wherein the first layer comprises:
the first layer, wherein the first face is a decorative element at least one of screened onto or milled into the outer side of the first layer.

15. The ornament of claim 12, wherein the compressible layer comprises:
the compressible layer configured for compressing upon coupling the ornament and the at least a second ornament.

16. The ornament of claim 12, wherein the compressible layer comprises:
the compressible layer configured for compressing upon coupling the ornament and the at least a second ornament, wherein compressing upon coupling the ornament and the at least a second ornament includes at least the compressible layer providing compressive forces against the inner side of the first layer and the inner side of the second layer.

17. The ornament of claim 12, wherein the compressible layer comprises:
the compressible layer configured for compressing upon coupling the ornament and the at least a second ornament, wherein compressing upon coupling the ornament and the at least a second ornament includes at least the compressible layer providing compressive forces against the inner side of the first layer and the inner side of the second layer, the compressive forces pushing the outer side of the first layer and the outer side of the second layer against an edge of the cutout of the ornament and having a tendency to hold the ornament and the at least a second ornament together.

18. The ornament of claim 12, wherein the edge comprises:
an edge of the first layer, an edge of the second layer, and an edge of the compressible layer defining the edge of the ornament.

19. An ornament, comprising:
a first face;
a second face;
an edge circumscribing the ornament disposed between the first face and the second face; and
an attachment arrangement configured for compressibly removably coupling the ornament to at least a second ornament, the attachment arrangement including at least one slot defined by a cutout of the ornament through the at least one edge, the at least one slot configured for removably receiving at least a second ornament via insertion of at least an edge of the at least a second ornament into the at least one slot, wherein at least a portion of the at least a second ornament compresses upon coupling the ornament and the at least a second ornament, the at least a portion of the at least a second ornament providing compressive forces against the inner side of the first layer and the inner side of the second layer, the compressive forces pushing the outer side of the first layer and the outer side of the second layer against an edge of the cutout of the ornament and having a tendency to hold the ornament and the at least a second ornament together.

20. An ornament, comprising:
a first face;
a second face;
an edge circumscribing the ornament disposed between the first face and the second face; and
a means for compressibly removably coupling the ornament to at least a second ornament.
